(19) United States
(12) Patent Application Publication
(10) Pub. No.: US 2024/0385627 A1
(43) Pub. Date: Nov. 21, 2024

(54) METHOD AND SYSTEM FOR WIND-OPTIMAL AIRSPEED TARGET AND AIRSPEED PREDICTIONS AT WAYPOINTS FOR USE IN FLIGHT MANAGEMENT SYSTEM (FMS)

(71) Applicant: United States of America as Represented by the Administrator of NASA, Washington, DC (US)

(72) Inventors: Priyank Pradeep, Santa Clara, CA (US); Gano Broto Chatterji, Sunnyvale, CA (US); Todd Andrew Lauderdale, Baltimore, MD (US); Heinz Erzberger, Los Altos Hills, CA (US)

(21) Appl. No.: 18/398,054

(22) Filed: Dec. 27, 2023

Related U.S. Application Data
(60) Provisional application No. 63/477,823, filed on Dec. 29, 2022.

(51) Int. Cl. G05D 1/65; G08G 5/00

(52) U.S. Cl. CPC G05D 1/65; G08G 5/003

(57) ABSTRACT

Systems, methods, and devices of the various embodiments may determine wind-optimal airspeed targets and predict wind-optimal airspeeds at waypoints in a flight plan and incorporate these values into a Flight Management System (FMS). A computing system may determine a wind-optimal airspeed in the presence of wind using the following method: i) create a lookup table for the wind-optimal airspeed as a function of aircraft type, wind magnitude, wind direction relative to the aircraft route/segment, and flight altitude to incorporate the lookup table in the performance database (PDB) of the FMS using RTCA DO-200 or an alternative process for the specific aircraft type; ii) use the FMS to target wind-optimal airspeed, and/or predict wind-optimal airspeed at waypoints in the flight plan in real-time (periodically and event based) by accessing the lookup table created and stored in the PDB using the required parameters.

### RELATED APPLICATIONS

This application claims the benefit of priority to U.S. Provisional Application No. 63/477,823 entitled, “Method and System for Wind-Optimal Airspeed Target and Airspeed Predictions at Waypoints Using Flight Management System,” filed Dec. 29, 2022, the entire contents of which are hereby incorporated by reference for all purposes.

### ORIGIN OF THE INVENTION

The invention described herein was made in the performance of work under a NASA contract and by (an) employee(s) of the United States Government and is subject to the provisions of Public Law 96-517 (35 U.S.C. § 202) and may be manufactured and used by or for the Government for governmental purposes without the payment of any royalties thereon or therefore. In accordance with 35 U.S.C. § 202, the contractor has elected not to retain title.

### FIELD OF THE INVENTION

The present disclosure relates generally to systems and methods for determining active airspeed target and planned airspeed predictions for aircraft flight mission. More particularly, the present disclosure relates to methods and systems for determining wind-optimal active airspeed target for automatic flight control systems (AFCS), mode control panel (MCP) or pilot based on level of automation in the aircraft and wind-optimal airspeed predictions at waypoints of the flight plan (e.g., active flight plan, secondary flight plan, what-if flight plan, route 2 flight plan, alternate flight plan, etc.).

### BACKGROUND

Integrated Modular Avionics (IMA), Distributed Integrated Modular Avionics (DIMA), Federated systems like Line Replaceable Unit (LRU), and the like are modern approaches to avionics. For example, IMA may consolidate multiple avionics functions and subsystems into a reduced number of standardized, shared hardware and software resources. IMA systems aim to employ a more efficient, flexible, cost-effective and modular architecture than traditional federated systems. A flight management system (FMS) is an advanced avionics system that enhances flight planning, navigation, and overall aircraft performance by integrating data from multiple sources and automating various tasks, thereby reducing pilot workload, and improving situational awareness. FMS may be implemented by IMA, DIMA, LRU, and the like.

For example, in commercial aviation, the FMS system may compute an airspeed by applying a specific wind blending algorithm that uses a mixture of sensed and forecasted wind information to predict aircraft trajectories for upcoming waypoints and/or for use by AFCS, MCP, and pilot. Examples of airspeed computations and wind blending algorithms may be found, for example, in: Priyank Pradeep, Todd A. Lauderdale, Heinz Erzberger, and Gano Broto Chatterji, “Wind-Optimal Cruise Airspeed for a Multirotor Aircraft in Urban Air Mobility,” AIAA 2022-0262, AIAA SCITECH 2022 Forum, January 2022, the entire contents of which are hereby incorporated by reference for all purposes. Examples of AFCS and MCP may be found, for example, in: U.S. Pat. No. 5,337,982 titled “Apparatus And Method For Controlling The Vertical Profile Of Aircraft” to Sherry; European Patent No. 0256564 titled “Intervention Flight Management System” to Graham et. al.; and European Patent No. 0122718 titled “Method And Apparatus For Automatic Aircraft Flight Control” to Zweifel, the entire contents of all of which are hereby incorporated by reference for all purposes. Examples of airspeed target computations may be found in U.S. Pat. No. 5,337,982 titled “Apparatus And Method For Controlling The Vertical Profile Of Aircraft” to Sherry, the entire contents of which are hereby incorporated by reference for all purposes. Examples of selected speed mode, performance database, airspeed prediction, and other similar elements may be found in European Patent No. 0719429 titled “Method Of Airplane Performance Estimation And Prediction” to Smith et al., the contents of which are hereby incorporated by reference for all purposes.

In an IMA system, the FMS may be one of many applications running on shared computing resources. The common platform provided by the IMA system may include processing, memory, and input/output resources that may be utilized by multiple avionics functions, including the FMS. Such sharing of resources may reduce the overall size, weight, power consumption, and cost of the avionics system. In addition to the FMS, other avionics applications and functions such as communication, navigation, surveillance, and flight control may also be integrated into the IMA. Each function may run as a separate application, with strict partitioning ensuring that the failure of one application does not affect the operations of the others. An application can comprise of a single or multiple functions.

These and other advancements in the fields of aviation and aerospace have led to the development of safer and more efficient aircraft and smarter flight planning solutions for various types of aircraft and flight missions. One such example is an electric vertical takeoff and landing (eVTOL) aircraft that employs distributed electric propulsion (DEP) systems.

While DEP systems provide many benefits over conventional propulsion systems, the flight endurance of aircraft powered solely by lithium-ion polymer (Li—Po) batteries is constrained due to their low specific energy, which is defined as the energy per unit weight. The ability to determine and employ flight parameters for energy efficient flight for these types of aircraft is especially important for increasing flight endurance.

### SUMMARY OF THE INVENTION

Various aspects include methods of operating an aircraft, which may include determining a zero-wind airspeed value based on information stored in a performance database (PDB) of the aircraft and a selected speed mode, determining a wind correction factor based on an aircraft type, including a fuel-powered, battery-powered and hybrid-powered fixed-wing, rotary-wing with single or multiple rotors or a combination of fixed-wing and rotary-wing aircraft, or a specific model of aircraft for example Boeing 737-800 and Joby Aviation S4 production prototype, or a specific aircraft identified with a unique registration number also known as the N-Number in US—or a unique vehicle identification number; and a sensed wind condition, in which the sensed wind condition may include a wind magnitude and a wind direction relative to a current segment of an flight plan of the aircraft, generating a wind-optimal airspeed value by adding the determined wind correction factor to the determined zero-wind airspeed value such as cruise airspeed value, determining an active airspeed target value based on the generated wind-optimal airspeed value, and adjusting an operational parameter of the aircraft by sending the active airspeed target value to the automatic flight control system (AFCS), mode control panel (MCP), or pilot based on a level of automation in the aircraft.

Some aspects may further include creating a wind-optimal airspeed value look-up table as a function of aircraft type, and a wind magnitude and a wind direction relative to a planned segment of the flight plan associated with a waypoint, and a flight altitude, and incorporating the wind-optimal airspeed value look-up table to the PDB using RTCA DO-2000 or a suitable process. In some aspects, generating the predicted wind-optimal airspeed value for each of the identified sequence of waypoints may include generating values that estimate an airspeed at each waypoint based on the following parameters a forecasted wind condition, the sensed wind condition, aircraft performance data, and the flight plan.

In some aspects, adjusting the operational parameter of the aircraft by sending the active airspeed target value to the AFCS, the MCP, or the pilot based on the level of automation in the aircraft may include adjusting the current airspeed of the aircraft based on the sensed wind condition to maintain an airspeed for the aircraft that reduces energy consumption or increases an operational range of the aircraft.

In some aspects, generating the wind-optimal airspeed value by adding the determined wind correction factor to the determined zero-wind airspeed value may include generating the wind-optimal airspeed value for flying a segment of the flight plan in the presence of wind.

Some aspects may further include accessing PDB specific to the aircraft type, determining a flight altitude value based on aircraft sensor data, collecting the sensed wind condition that may include the wind magnitude and the wind direction, determining an angle between the wind direction and a direction of an active flight segment, computing the wind-optimal airspeed value by accessing the wind-optimal airspeed value look-up table incorporated in the PDB based on the aircraft type, the collected sensed wind condition, the determined angle, and the determined flight altitude value, and generating a wind-optimal airspeed target value based on the computed wind-optimal airspeed value. In some aspects, adjusting the operational parameter of the aircraft by sending the active airspeed target value to the AFCS, the MCP, or the pilot based on the level of automation in the aircraft further may include using the generated wind-optimal airspeed target value to adjust the controls of the aircraft or provide advisories to the pilot to achieve or maintain the wind-optimal airspeed and guide the aircraft along an energy-efficient path.

Some aspects may further include accessing PDB specific to the aircraft type, collecting the sensed wind condition that may include the wind magnitude and the wind direction, determining a great-circle distance between a current position of the aircraft and a waypoint in the flight plan, collecting a forecasted wind condition along the flight plan, blending the forecasted wind condition with the sensed wind condition to predict a wind condition at each waypoint in the flight plan, determining an angle between a predicted wind condition and a direction of a segment of the flight plan ending at the waypoint in the flight plan, determining the wind-optimal airspeed value based on the aircraft type, the determined angle, the predicted wind condition, and a flight altitude using the wind-optimal airspeed value look-up table incorporated in the PDB, and predicting the wind-optimal airspeed value for the waypoint in the flight plan based on the determined wind-optimal airspeed value. In some aspects, adjusting the operational parameter of the aircraft by sending the active airspeed target value to the AFCS, the MCP, or the pilot based on the level of automation in the aircraft further may include updating the flight plan based on the predicted wind-optimal airspeed value.

Further aspects may include a computing device having a processor configured with processor-executable instructions to perform various operations corresponding to the methods discussed above.

Further aspects may include a computing device having various means for performing functions corresponding to the method operations discussed above.

Further aspects may include a non-transitory processor-readable storage medium having stored thereon data and/or processor-executable instructions configured to cause a processor to perform various operations corresponding to the method operations discussed above.

### BRIEF DESCRIPTION OF THE DRAWINGS

The accompanying drawings, which are incorporated herein and constitute part of this specification, illustrate exemplary embodiments of the claims, and together with the general description given above and the detailed description given below, serve to explain the features of the claims.

FIG. 1 is a system block diagram of a computing system in the form of a system in a package (SIP) that may be included in an aircraft or in part in a ground control station (GCS) and configured to implement some embodiments.

FIG. 2 is a process flow diagram illustrating a method of determining active airspeed target and planned airspeed predictions at waypoints of the flight plan in accordance with some embodiments.

FIG. 3 is a block diagram illustrating components and operations in a system configured to use a performance database to perform real-time computations of wind-optimal airspeed values for active airspeed target and planned airspeed predictions at waypoints in the flight plan in accordance with some embodiments.

FIG. 4 is a block diagram illustrating components and operations in a system configured to determine wind-optimal airspeed value at a waypoint in the flight plan in accordance with some embodiments.

FIGS. 5A and 5B are process flow diagrams illustrating a method of generating and using the wind-optimal airspeed in accordance with some embodiments.

FIG. 6 is a process flow diagram illustrating a method of generating a predicted wind-optimal airspeed in accordance with some embodiments.

FIG. 7 is a process flow diagram illustrating a method of setting an airspeed target in accordance with some embodiments.

FIG. 8 is a process flow diagram illustrating a method of creating and using a lookup table for wind-optimal airspeed in accordance with some embodiments.

FIGS. 9-11 are process flow diagrams illustrating methods of operating an aircraft in accordance with some embodiments.

### DETAILED DESCRIPTION OF THE INVENTION

The various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

In overview, the various embodiments include methods, and computing systems configured to perform the methods of determining a wind-optimal active airspeed target and predicting planned wind-optimal airspeed at waypoints in a flight plan and incorporating these values into a Flight Management System (FMS). In aviation, airspeed is the speed of an aircraft relative to air that it is flying through. In some embodiments, the computing system may include a processing system that is configured with processor-executable instructions to determine a wind-optimal airspeed for flying a flight plan trajectory, including a great circle trajectory, in the presence of wind. In some embodiments, the processing system may be configured to create a lookup table for the performance database (PDB) of the FMS that includes aircraft and engine model data, which may include thrust, drag, fuel flow, airspeed and altitude envelopes, and variety of optimized speed schedules that are unique to the aircraft type. An “aircraft type” may refer to a specific make and model of an aircraft, with a unique design, configuration, and capabilities. In some embodiments, the processing system may be configured to use the FMS to target wind-optimal airspeed. In some embodiments, the processing system may be configured to predict wind-optimal airspeed at waypoints in the flight plan using the FMS. In some embodiments, the wind-optimal airspeed may be used as a selected speed mode for airspeed predictions at waypoints in active, secondary, what-if, route 2, and/or alternate (alternative) flight plans.

In some embodiments, the processing system may be configured to compute the wind-optimal airspeed, using a lookup table in the PDB (unique to an aircraft type) of the FMS. A wind-optimal airspeed value may be determined as a function of sensed/forecast wind magnitude, sensed/forecast wind direction relative to a segment of a flight plan, and flight altitude using the FMS.

In some embodiments, the processing system may be configured to determine a blending of sensed wind and forecast wind based on the formula Predicted_{wind}=Wind_{Sensed}/{1+(d/D)\hat{ }2}+Wind_{Forecast}(d/D)\hat{ }2{1+(d/D)\hat{ }2}, which is discussed in more detail further below. In some embodiments, the processing system may be configured to compute the wind-optimal airspeed for a waypoint in the flight plan based on the blending of sensed wind and forecast wind, flight altitude, and angle between the predicted wind and predicted flight segment (ending at the waypoint).

In some embodiments, the processing system may be configured to populate a lookup table with the wind-optimal airspeed values. In some embodiments, the processing system may incorporate wind-optimal airspeed lookup tables for several types of aircraft (e.g., multirotor, fixed-wing aircraft, etc.). In some embodiments, the processing system may incorporate the wind-optimal airspeed lookup table into the PDB of the FMS (e.g., for automatic flight control systems, electronic flight bags, etc.). The FMS may access the PDB in real-time to control the operating parameters (e.g., airspeed, etc.) of the aircraft.

In some embodiments, the processing system may be configured to compute a selected airspeed (No wind conditions) based on the information in the PDB, add a wind correction factor to the airspeed computed using forecast/sensed wind (e.g., Wind-optimal airspeed=computed selected airspeed+wind-correction factor), and set the airspeed target to the wind-optimal airspeed.

The embodiments may improve the performance and functioning of the aircraft and its electronic components by enhancing flight efficiency and/or improving safety in rotary-wing and fixed-wing aircraft sectors. Other improvements to the performance and functioning of the aircraft and its components will be evident from the disclosures below.

The terms “component,” “module,” “system,” “manager,” and the like may be used in this application to refer to a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer.

By way of illustration, both an application running on a computing device and the computing device may be referred to as a component. One or more components may reside within a process and/or thread of execution and a component may be localized on one processor or core and/or distributed between two or more processors or cores. In addition, these components may execute from various non-transitory computer-readable media having various instructions and/or data structures stored thereon. Components may communicate by way of local and/or remote processes, function or procedure calls, electronic signals, data packets, memory read/writes, and other known network, computer, processor, and/or process-related communication methodologies.

The term “system on chip” (SOC) is used herein to refer to a single integrated circuit (IC) chip that contains multiple resources or processors integrated on a single substrate. A single SOC may contain circuitry for digital, analog, mixed-signal, and radio-frequency functions. A single SOC also may include any number of general-purpose or specialized processors (digital signal processors, modem processors, video processors, etc.), memory blocks (such as ROM, RAM, Flash, etc.), and resources (such as timers, voltage regulators, oscillators, etc.). SOCs also may include software for controlling integrated resources and processors, as well as for controlling peripheral devices.

The term “system in a package” (SIP) may be used herein to refer to a single module, a single SOC or a package that contains multiple resources, computational units, cores or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP also may include multiple independent SOCs coupled together via high-speed communication circuitry and packaged in close proximity, such as on a single motherboard or in a single wireless device. The proximity of the SOCs facilitates high-speed communications and the sharing of memory and resources.

Urban Air Mobility (UAM)/Advanced Air Mobility (AAM) is an emerging group of aviation technologies and solutions that focus on the development and deployment of advanced air transportation systems in urban environments. By leveraging advancements in automation, electrification, and connectivity, these systems and solutions may transform urban transportation systems and shape the cities of the future. For example, UAM envisions a future in which air travel is an integral part of the transportation networks within cities. This may be accomplished by using innovative aircraft such as electric vertical takeoff and landing (eVTOL) aircraft that are designed to operate in dense urban environments.

An electric vertical takeoff and landing (eVTOL) aircraft is a type of aircraft that combines the convenience of helicopters with the efficiency and speed of fixed-wing airplanes. eVTOLs may be capable of ascending and descending vertically (similar to a helicopter). These and other features may eliminate the need for runways and/or otherwise make eVTOLs especially appealing for use in densely populated urban areas. In addition, eVTOLs may be electric motor powered for quieter operation and lower environmental impact compared to traditional fossil fuel-based aircraft engines. eVTOLs are typically equipped with multirotors or multipropellers or multifans that allow for stable hovering and maneuvering in different directions and forward flight. eVTOLs may be equipped with advanced flight control systems, often with a high degree of automation for ease of operation and enhanced safety. Due to their unique combination of features and capabilities, eVTOLs may play an increasingly significant role in future UAM solutions.

A flight management system (FMS) is a component of contemporary avionics that is used to enhance aircraft efficiency, increase safety, and reduce the workload of pilots.

The FMS may be a specialized computer system or an onboard avionics system that is installed within the aircraft (e.g., commercial aircraft, eVTOLs, etc.) and/or in the GCS that manages all phases of flight, including takeoff, climb, cruise, descent, and landing. For example, the FMS may be integrated within the aircraft's cockpit and in the GCS and accessible via control panels for pilot interaction. The FMS may include various components (implemented in software, database, firmware, hardware, etc.) that coordinate aircraft performance, flight planning, communication, navigation, and flight control systems. The FMS may control the aircraft's speed and altitude, and perform various in-flight tasks, such as managing the flight plan and autopilot functions to autonomously guide the aircraft to its destination (i.e., when it is coupled with an automatic flight control system (AFCS), etc.). The FMS onboard the aircraft may interface with multiple other systems within the aircraft, including the global positioning system (GPS) and other sensors, to collect real-time data about the flight and environment. The FMS in the GCS may receive data from the remote aircraft and from satellite and ground-based sources. In some embodiments, the FMS onboard the aircraft may be configured to work in conjunction with a ground control station as part of manned, unmanned, and/or semi-autonomous operations.

In some embodiments, the FMS may include a speed generator component configured to calculate an “active airspeed target” for the aircraft. The active airspeed target may be a value that is used as a reference for the pilots or as a direct input to the autopilot system to improve the performance of the aircraft (e.g., minimize fuel consumption/energy usage, maximize airspeed, etc.) in relation to its flight plan. In various embodiments, the speed generator component may be configured to determine the active airspeed target value based on multiple factors, such as the aircraft's current altitude, weight, performance characteristics, current weather conditions, forecasted weather conditions, wind magnitude and direction, flight plan, flight mission, etc. In some embodiments, the speed generator component may be configured to dynamically (periodically or event-based) update or adjust the target airspeed value as conditions change throughout the flight (e.g., to ensure the aircraft is flying as efficiently as possible, etc.). In some embodiments, updating or adjusting the active airspeed target value may cause the aircraft to change or adjust its current operating parameters (e.g., current airspeed, etc.).

In some embodiments, the FMS may include several pre-selectable speed modes, such as long-range cruise (LRC), economy (ECON), maximum endurance, and maximum reserve speed. Each of these modes may correlate with a certain airspeed target and airspeed predictions computed by the speed generator and/or in real-time. In some embodiments, the speed generator and/or FMS may send a speed command directly to the AFCS to adjust or control the aircraft's speed.

In some embodiments, the speed generator and/or FMS may be configured to adjust or control the aircraft's speed based on one or more aviation values/parameters, such as best range airspeed, selected airspeed, and wind-optimal airspeed. The “best range airspeed” may be an aviation parameter that identifies an airspeed at which the aircraft may achieve the maximum distance per unit of fuel or per unit of energy. The “selected airspeed” may be an aviation parameter that identifies the speed at which the aircraft is most efficient under neutral wind conditions. The “wind-optimal airspeed” may be an aviation parameter that aids aircraft efficiency. For example, the wind-optimal airspeed may identify the most efficient airspeed that considers current wind conditions, and flight plan to minimize fuel burn/energy usage, and/or increases flight endurance.

A “waypoint” may be a specific geographical location (e.g., latitude, longitude, altitude, etc.) used to define an aircraft's flight plan (or flight plan). The flight plan may include an origin and a destination, a sequence of waypoints, airways, flight levels, airspeeds, and departure and arrival procedures for an aircraft to fly from the origin to the destination. In some embodiments, the FMS may be configured to identify a sequence of waypoints in the aircraft's flight plan and adjust or control the aircraft's speed based on one or more aviation parameters associated with each of the sequence of waypoints. That is, since the aircraft may encounter different wind conditions at each waypoint, the value of the wind-optimal airspeeds may be different at/for each waypoint. Accordingly, the FMS may dynamically adjust the airspeed at each waypoint based on changes to dynamically determined wind-optimal airspeed values.

Some embodiments may include components (e.g., FMS, speed generator, SOC, processing system, etc.) configured to improve flight route planning by minimizing energy usage and considering both actual and forecasted wind conditions. These embodiments may be particularly relevant for slower aircraft (e.g., general aviation aircraft, package delivery drones, multirotor eVTOLs, etc.) that are more susceptible to wind conditions. Some embodiments may include components configured to use the aircraft's performance database (PDB) to compute a selected airspeed value in “no wind” conditions. For example, the components may determine a zero-wind airspeed value based on information stored in the PDB of the aircraft and a selected speed mode. The components may determine a wind correction factor based on various parameters (e.g., forecasted wind condition, sensed wind condition, wind magnitude and direction of the wind relative to the flight route, flight altitude, etc.), add the wind correction factor to the selected airspeed value (or zero-wind airspeed value) to generate the wind-optimal airspeed value, determine a target airspeed value based on the wind-optimal airspeed value, and provide this target airspeed value to the aircraft flight management and control systems (FMS, AFCS, etc.), mode control panel (MCP), and/or the pilots based on level of automation in the aircraft to adjust the aircraft's current airspeed accordingly.

In some embodiments, the components may be configured to compute the “wind-optimal airspeed” to be equal to the best range airspeed plus a wind correction factor that considers wind magnitude, direction relative to the route, flight altitude, etc.

In some embodiments, the components may be configured to generate predicted values that estimate the wind-optimal airspeed at waypoints throughout the flight plan. For example, the components may use the FMS to estimate the most efficient airspeed at future points (waypoints) along the aircraft's planned route based on data such as meteorological forecast data, aircraft performance data, and/or flight plan details. The components may use any or all of such information to predict how the airspeed should change as the aircraft progresses along its flight plan. These predictions may enable the aircraft to plan ahead for changes in speed to maintain the most efficient flight possible. Such forward-planning capability may increase the overall efficiency of the flight and improve flight safety by enabling better flight planning and reducing workload for pilots.

In some embodiments, the components may be configured to generate a lookup table for aircraft type-specific wind-optimal airspeed (factoring in the wind magnitude, direction relative to the route, and the flight altitude specific to the aircraft type), and integrate this wind-optimal airspeed lookup table into the PDB using Radio Technical Commission for Aeronautics (RTCA) DO-200 (standards for processing aeronautical data) or a suitable process for real-time access by the FMS so as to allow the aircraft to target wind-optimal airspeed and/or predict wind-optimal airspeed at waypoints in the flight plan autonomously. Targeting the wind-optimal airspeed may include repeatedly adjusting the aircraft's airspeed to maintain an airspeed for the aircraft that minimizes energy consumption given the current and forecasted wind conditions. That is, by considering real-time wind conditions, the components may generate, command and/or enforce more energy-efficient airspeeds that reduce energy consumption, increase the operational range, and/or otherwise enhance the sustainability of currently operating aircraft and next-generation aircraft or air vehicles.

As mentioned above, advancements in the fields of aviation and aerospace have led to the development of more efficient and smarter flying solutions. eVTOL aircraft that include distributed electric propulsion (DEP) systems are a contemporary instance of these advancements. Energy-efficient flight is important especially for commercial viability of aviation. Even small amount of fuel savings—5% per flight—can boost annual profits because of the scale of operations—45,000 flights per day in the US alone. Energy-efficient flight planning is even more important for aircraft with battery powered DEP systems because of the low specific energy of the lithium-ion polymer (Li—Po) batteries. necessitate energy-efficient flight planning. By computing wind-optimal airspeed targets and airspeed predictions at waypoints, the embodiments may enable currently operational aircraft and emerging aircraft to maintain wind-optimal airspeed for reduced energy consumption and increased flight endurance.

In addition to reduced energy consumption and increased flight endurance, there are a number of other operational benefits for flying at wind-optimal airspeed, especially in headwind conditions. For example, when compared to maintaining the best-range airspeed, maintaining a wind-optimal airspeed under uncertain wind conditions may increase predictability and reduce variability in the energy consumption characteristics of the aircraft. Indeed, test applications on multirotor eVTOL aircraft in UAM environment have demonstrated significant advantages of flying at wind-optimal airspeed compared to the best-range airspeed. In headwind conditions, energy consumption was reduced by up to 7.5% and flight duration was cut by up to 28%. In tailwind conditions, energy consumption showed an improvement of up to 2% at the cost of a slightly longer flight duration. The results also indicated that under uncertain wind magnitudes, flying at wind-optimal airspeed offered lower variability and higher predictability in energy consumption.

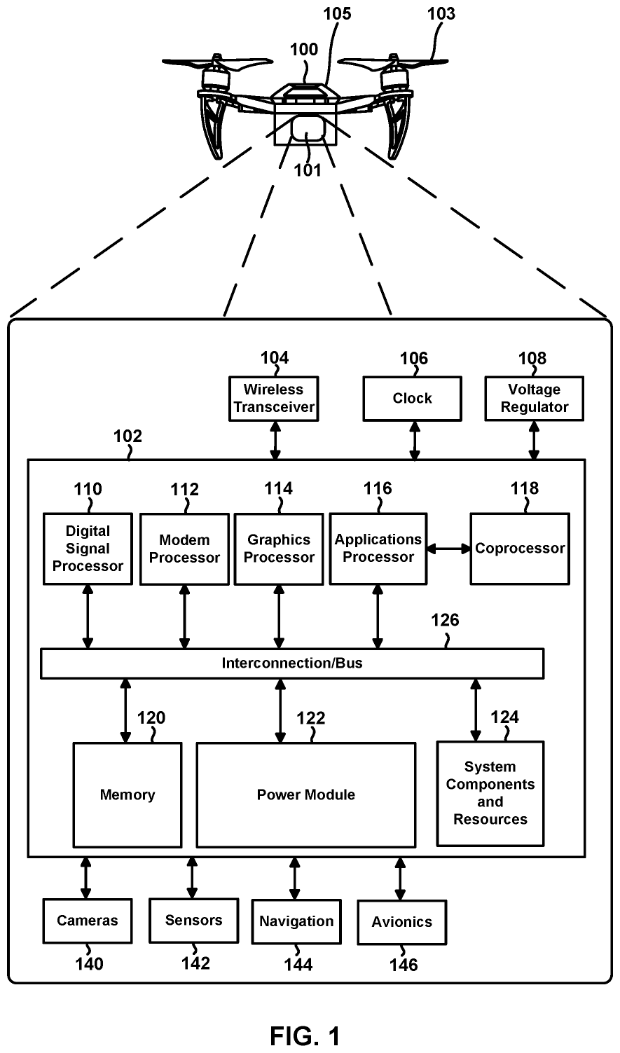

FIG. 1 is an illustration of an example aircraft 100 that is equipped with a computing system 101 suitable for implementing some embodiments. In the example illustrated in FIG. 1, the aircraft 100 includes rotors 103 and a frame 105 that provides structural support for the motors associated with the rotors 103. For ease of description and illustration, some detailed aspects of aircraft 100 are omitted such as wiring, frame structure interconnects, or other features that would be known to one of skill in the art. In addition, while the aircraft 100 is shown and described as having rotors 103 and a frame 105, it should be understood that the aircraft 100 may include a full-sized aircraft body, wings, and/or other known components of modern aircraft. For example, it should be understood that in some embodiments the aircraft 100 may be an eVTOL aircraft, fixed-wing aircraft, jet aircraft, turbo-prop aircraft, gas-electric hybrid aircraft, and aircraft using alternative sources of power such as hydrogen. Accordingly, nothing in the claims should be limited to propeller or rotor based aircraft unless expressly recited as such in the claims.

Returning to FIG. 1, the aircraft 100 may include a processing system or a computing system 101 that includes or implements an IMA, FMS, AFCS, MCP, any of the components discussed in this application, and/or other features and functions of the aircraft 100. In some embodiments, the computing system 101 may be a SIP that includes an SOC 102, wireless transceiver 104, clock 106, voltage regulator 108, cameras 140, sensors 142, navigation 144 components, and avionics 146 components. A modern SOC or a package of SOCs 102 may include a digital signal processor (DSP) 110, modem processor 112, graphics processor 114, applications processor 116, and a co-processor 118 (e.g., vector co-processor, etc.). The SIP, SOC 102, and/or any or all of the processors 110, 112, 114, 116, 118 may be FMS processors configured to implement all or portions of a flight management system and/or any or all of the embodiments discussed herein. The processors 110, 112, 114, 116, 118 may be interconnected to each other and to one or more memory elements 120, power module 122, and system components and resources 124 via an interconnection/bus module 126. The interconnection/bus module 126, may include an array of reconfigurable logic gates and/or implement a bus architecture (e.g., CoreConnect, AMBA, etc.). Communications may be provided by advanced interconnects, such as high-performance networks-on-chip (NoCs).

In various embodiments, the SOC 102 and/or any of the processors 110, 112, 114, 116, 118 may be configured to operate as a central processing unit (CPU) that carries out the instructions of software application programs by performing the arithmetic, logical, control and input/output (I/O) operations specified by processor-executable instructions. For example, the CPU may be configured with processor-executable instructions to control the travel and other operations of the aircraft 100, including operations of various embodiments. Each processor 110, 112, 114, 116, 118 may include one or more cores, and each processor/core may perform operations independent of the other processors/cores. For example, the SOC 102 may include a processor that executes a first type of operating system (e.g., FreeBSD, LINUX, OS X, etc.) and a processor that executes a second type of operating system (e.g., MICROSOFT WINDOWS 11).

In addition, any or all of the processors 110, 112, 114, 116, 118 may be included as part of a processing system or processor cluster architecture (e.g., a synchronous processor cluster architecture, an asynchronous or heterogeneous processor cluster architecture, etc.) and/or included as one or more nodes in one or more CPU clusters. A CPU cluster may be a group of interconnected nodes (e.g., processing cores, processors, SOCs, SIPs, computing devices, etc.) configured to work in a coordinated manner to perform a computing task. Each node may run its own operating system and contain its own CPU, memory, and storage. A task that is assigned to a CPU or CPU cluster may be divided into smaller tasks that are distributed across the individual nodes for processing. The nodes may work together to complete the task, with each node handling a portion of the computation. The results of each node's computation may be combined to produce a final result. CPU clusters are especially useful for tasks that can be parallelized and executed simultaneously. This allows CPU clusters to complete tasks much faster than a single similar CPU and often a single high-performance computer. Additionally, because CPU clusters are made up of multiple nodes, they are often more reliable and less prone to failure than a single high-performance component.

The SOC 102 may include various system components, resources, and custom circuitry for managing sensor data, analog-to-digital conversions, wireless data transmissions, and for performing other specialized operations. For example, the system components and resources 124 may include power amplifiers, voltage regulators, oscillators, phase-locked loops, peripheral bridges, data controllers, memory controllers, system controllers, access ports, timers, and other similar components used to support the processors and software clients running on a mobile computing device. The system components and resources 124 may also include circuitry to interface with peripheral devices, such as cameras 140, electronic displays, wireless communication devices, external memory chips, etc.

The power module 122 may include a power management and control unit and/or one or more batteries or connection to an aircraft power source power generated onboard the aircraft or outside that may provide power to various components, including the processor 110, 112, 114, 116, 118, the sensors 142, the cameras 140, etc. In addition, the power module 122 may include energy storage components, such as rechargeable batteries. The power module 122 and/or the CPU may be configured to manage or control the charging of the power module 122 (i.e., the storage of harvested energy), such as by executing a charging control algorithm using a charge control circuit.

The camera 140 may include image sensor or optical sensor (e.g., a sensor capable of sensing visible light, infrared, ultraviolet, and/or other wavelengths of light). The sensors 142 may include an accelerometer, magnetometer, a gyroscope, GPS, or other similar sensors. For example, the sensors 142 may also include a radio frequency (RF) sensor, airspeed sensor, angle-of-attack sensor, a barometer, air temperature sensor, a humidity sensor, a sonar emitter/detector, a radar emitter/detector, a microphone or another acoustic sensor, a lidar sensor, a time-of-flight (TOF) 3-D camera, or another sensor that may provide information usable for movement operations, positioning, guidance, navigation and control calculations, and determining environmental conditions.

The navigation unit 144 may include a planning application that may perform calculations to plan a path of motion for the aircraft 100 within a volumetric space (“path planning”). In some embodiments, the planning application may perform path planning using information including information about aspects of a task to be performed by the aircraft 100, environmental condition information, an amount of heat that may be generated by one or more components of the aircraft 100 in performing the task.

The avionics 146 component may be coupled to the CPU and/or the navigation unit 144. The avionics 146 component may be configured to provide travel control-related information such as altitude, attitude, airspeed, heading, and similar information that the navigation unit 144 may use for navigation purposes, such as dead reckoning between global navigation satellite system (GNSS) position updates. The avionics 146 may include or receive data from sensors 142 that provide data regarding the orientation and accelerations of the aircraft 100 that may be used in navigation and positioning calculations, as well as providing data used in various embodiments.

The SOC 102 may further include an input/output module (not illustrated) for communicating with resources external to the SOC, such as the wireless transceiver 104 (e.g., cellular wireless transceiver, Bluetooth transceiver, etc.), clock 106, or voltage regulator 108. Resources external to the SOC may be shared by two or more of the internal SOC processors/cores or SIPs.

In addition to the example SIP or computing system 101 discussed above, various embodiments may be implemented in a wide variety of computing systems, which may include a single processor, multiple processors, multicore processors, or any combination thereof.

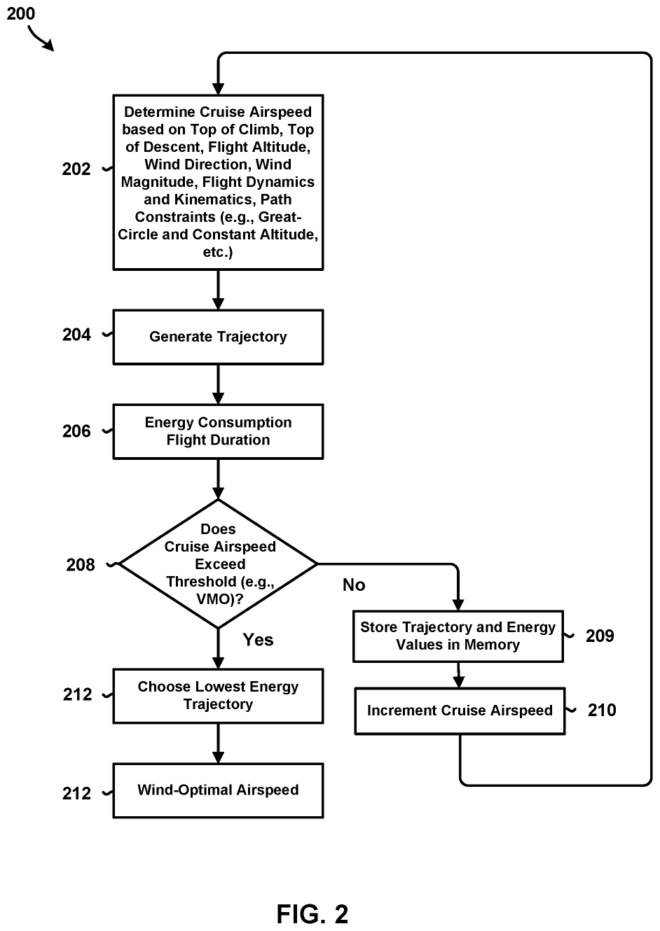

FIG. 2 illustrates a method 200 of determining airspeed and trajectory values in accordance with some embodiments. Method 200 may be performed by a processor or processing system in a computing system (e.g., which may include IMA, FMS, etc.) in an aircraft to, for example, enable wind-optimal airspeed control for improved flight efficiency and safety. The operational sequence of method 200 may allow the system to iteratively improve the efficiency of the flight plan, considering both airspeed and wind conditions for optimal energy consumption and flight duration.

In block 202, the processing system (e.g., FMS processor, etc.) may determine an airspeed value. In some embodiments, the processing system may determine the airspeed value based on any of a variety of factors, such as conditions, or values, such as top of climb (TOC), top of descent (TOD), flight altitude, wind conditions, flight dynamics and kinematics, and trajectory constraints (e.g., a great-circle, flight plan, altitude and speed constraints, and required time of arrival at waypoints.)

A TOC value may identify the location where an aircraft ends its ascent, and levels off for the cruise portion of the flight. The speed at which this climb is performed may influence the transition to cruise airspeed computations. For example, depending on the aircraft's performance characteristics, faster climbs may be followed by slower cruise speeds (and vice versa).

A TOD value may identify the location where the aircraft begins its descent toward its destination. A required descent speed or threshold may impact the transition from cruise airspeed computations.

The flight altitude value may identify the altitude at which the aircraft travels during a portion of the flight. Higher altitudes may allow for higher speeds with less drag (e.g., because air is thinner, etc.). As such, the flight altitude value may have a significant impact on the airspeed computations. In some embodiments, the processing system may be configured to determine the flight altitude value so as to balance aerodynamic factors with engine efficiency. The flight altitude value may also be determined to change in steps or continuously as a function of the weight of the aircraft, whereby the aircraft climbs for a portion of the flight as it burns fuel and gets lighter.

The wind conditions including the speed and direction of the wind may also significantly impact the effective speed of the aircraft over the ground. For example, a headwind (wind blowing against the direction of travel) may reduce ground speed, whereas a tailwind (wind blowing in the same direction) may increase it.

Flight dynamics and kinematics information structures and values may identify factors such as the aircraft's weight, balance, and aerodynamic characteristics, which may all impact the optimal airspeed. For example, a heavier aircraft may need to fly faster to maintain altitude.

The planned route of the aircraft may also influence the airspeed computations. For example, great-circle routes (e.g., the shortest path between two points on the globe, etc.) may include trajectory constraints and/or require different speeds than others, including other types of routes. Similarly, the airspeed computations may be impacted if the flight plan includes a requirement to maintain a constant altitude.

In block 204, the processing system may generate a trajectory for the aircraft's flight. The flight trajectory may be the path that the aircraft follows from its departure location to its destination location. In some embodiments, the generated flight trajectory may be a three-dimensional value or information structure that identifies changes in latitude, longitude, and altitude. In some embodiments, the trajectory may be an ordered sequence of time, latitude, longitude, and altitude values along the current, planned or trial route of flight.

In some embodiments, generating the trajectory in block 204 may include evaluating factors such as the flight plan, wind conditions (e.g., speed and direction of the wind, etc.), aircraft performance parameters, obstacles (e.g., terrain or airspace restrictions, etc.). A flight plan may outline the intended route of the aircraft and incorporate elements such as waypoints, airways, and specific constraints (e.g., air traffic control (ATC) requirements, etc.). In some embodiments, the processing system may generate the trajectory in block 204 to ensure enhanced flight performance based on wind speed and direction. For example, the aircraft may modify the trajectory or route, ‘crab’ or angle into the wind to adhere to the intended route, etc. In some embodiments, the processing system may generate the trajectory in block 204 based on other aircraft performance factors (e.g., climb rate, descent rate, turn radius, power, thrust etc.) and/or to account for how the aircraft will move through three-dimensional space. In some embodiments, the processing system may generate the trajectory in block 204 to account for physical and regulatory restrictions (e.g., avoiding mountains or other obstacles, staying clear of restricted airspace, adhering to altitude constraints, etc.). By considering these and other factors, the processing system may generate an improved or enhanced trajectory that considers the determined airspeed values, follows the most efficient and safe path from departure to destination, and accounts for current conditions, forecasted conditions, aircraft capabilities, and airspace regulations.

In block 206, the processing system may use the generated trajectory to estimate energy consumption and flight duration. In some embodiments, the processing system may use the generated trajectory along with the aircraft's performance characteristics to estimate energy consumption and flight duration. For example, the processing system may generate estimated energy consumption values throughout the flight based on the estimates, measurements or a combination of measurements and estimates of thrust, power, amount of fuel or battery-energy required by the aircraft to fly the trajectory.

Generally, different segments of the flight (e.g., takeoff, climb, cruise, descent, landing, etc.) may have different energy requirements. For example, the climb and takeoff segments may require more energy than the cruise segment. As such, in some embodiments, the processing system may be configured to determine the estimated energy consumption value in block 206 based on the aircraft's speed, altitude, weight, engine performance, and aerodynamic efficiency throughout each segment of the trajectory. In some embodiments, the processing system may be configured to determine the estimated energy consumption value by summing up energy estimate values for each of a plurality of flight segments.

In some embodiments, the processing system may be configured to determine the estimated flight duration value in block 206 based on the total distance of the trajectory and the aircraft's speed at each segment of the flight. In some embodiments, the processing system may also take into account factors such as the speed and direction of the wind, which may have a significant impact on the actual flight time. For example, a strong headwind might slow the aircraft down (extending the flight time) and a strong tailwind may speed the aircraft up (reducing the flight time). In some embodiments, a required time-of-arrival may be provided as a constraint to the processing system. In some embodiments, the processing system may be configured to determine the estimated energy consumption and estimated flight duration values by simulating the flight along the calculated trajectory, taking into account any or all of the factors discussed above.

In block 208, the processing system may compare the computed airspeed to a threshold value to determine whether the airspeed parameter equals or exceeds a threshold value (e.g., equals VMO or the Max Operating Airspeed, etc.). In some embodiments, the threshold value may be a safety limit, a performance limit, an optimal airspeed under certain conditions, or another similar value chosen based on the specific requirements or constraints of the aircraft and/or flight plan such as speed, altitude and required time-of-arrival at a waypoint or at the destination.

In response to determining that the computed airspeed parameter does not equal or exceed the threshold (i.e., determination block 208=“No”), the processing system may store the trajectory and the associated energy consumption and flight duration of the said trajectory in block 209, determined earlier in blocks 204 and 206, in memory accessible to the processing system. The processing system may increment the computed airspeed in block 210 and repeat the operations in blocks 202-208 with the new incremented airspeed. For example, the processing system may generate a new trajectory, estimate the energy consumption and flight duration with the new airspeed, and check again to determine whether the new computed airspeed exceeds the threshold value. The processing system may perform these operations iteratively until the computed airspeed equals or exceeds the threshold value.

In response to determining that the computed airspeed parameter equals or exceeds the threshold (i.e., determination block 208=“Yes”), in block 212 the processing system may retrieve the trajectories and their energy consumption and flight time values, stored in the memory by block 209, from the memory and select a minimum energy trajectory. The “minimum energy trajectory” may be an optimal flight plan determined to consume the least amount of energy and is important for aircraft that aim to optimize their fuel or battery usage to extend flight times and efficiency. In some embodiments, the processing system may determine the minimum energy trajectory by evaluating the data accumulated during the iterative process described in blocks 202-208. For example, the processing system may compare the estimated energy consumption and flight durations associated with the various tested computed airspeeds, and select the trajectory associated with the computed airspeed that resulted in the lowest estimated energy consumption. As such, the iterative process discussed above may allow the FMS to adjust and optimize the flight parameters in real-time, contributing to a more efficient and safer flight operation. In some embodiments, the first trajectory and its energy and flight time values are stored in the memory accessible to the processing system. The second trajectory and its energy and flight time values obtained in next iteration of the process described in blocks 202-208 are compared with the first trajectory and its associated energy and flight time values stored in the memory to select one of the two trajectories, either the first or the second trajectory, based on energy and flight time. The selected trajectory and its energy and flight time values are stored in the memory as the first trajectory values. This process of storing and comparing trajectory values is repeated after each iteration of the process described in blocks 202-208. The last remaining trajectory in the memory is retrieved and selected in block 212.

In block 214, the processing system may determine the wind-optimal airspeed parameter for the aircraft. For example, the processing system may set the value of the wind-optimal airspeed parameter based on (or equal to) the determined minimum energy trajectory. As mentioned above, the value of the wind-optimal airspeed parameter may identify the airspeed that minimizes energy consumption or minimizes flight time or maximizes flight endurance in the presence of wind based on the selected speed mode. Throughout the flight, the processing system may continue to monitor and adjust the wind-optimal airspeed as conditions change, ensuring the aircraft is always flying as efficiently as possible given the prevailing and forecasted conditions.

As mentioned above, the FMS may use a sequence of lookup tables, housed in the PDB, containing critical engine, aerodynamic, and performance data. This data may be used in real-time by the FMS, which may use interpolation to extract information from these tables. Similarly, some embodiments may use a wind-optimal airspeed lookup table that is designed and integrated into the PDB for a specific aircraft type, and which may follow the radio technical commission for aeronautics (RTCA) DO-200 standards or a suitable alternative process for processing aeronautical data. The FMS may access the PDB in real-time to pilot the aircraft at the wind-optimal airspeed.

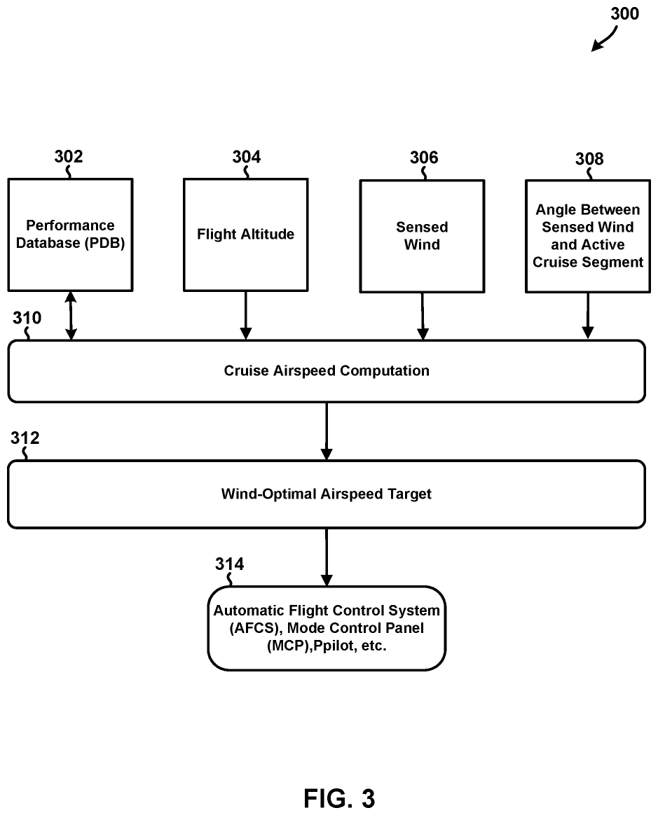

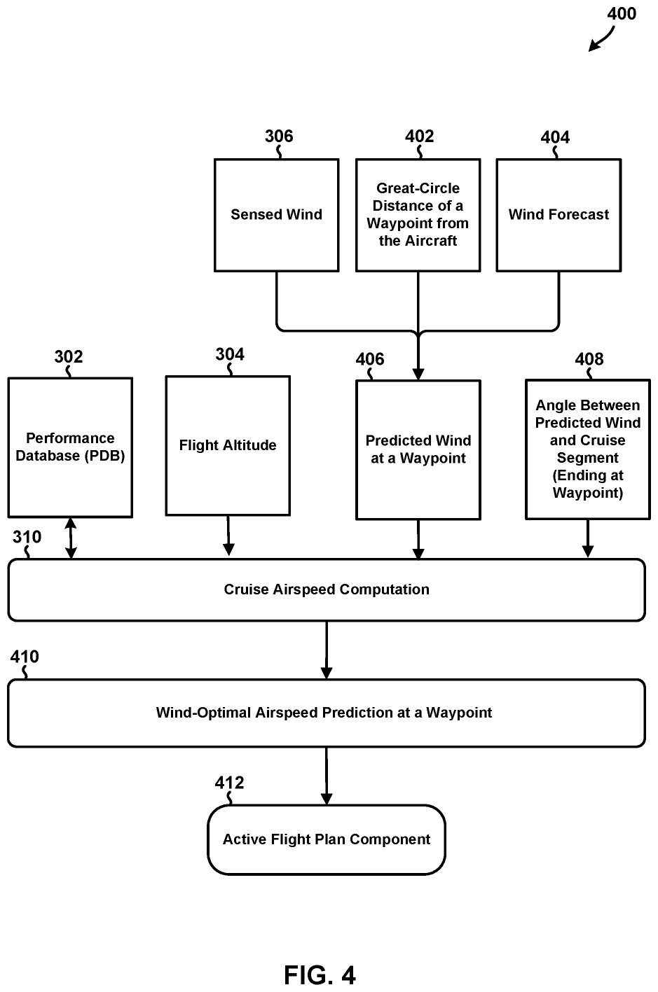

FIGS. 3 and 4 illustrate example components in a system 300, 400 that may be included in an aircraft (e.g., aircraft 100, etc.) and/or in part in the GCS and configured to implement the various embodiments. In particular, FIG. 3 illustrates an example in which the real-time computation of a wind-optimal airspeed target for an automatic flight control system utilizes the PDB, factoring in parameters such as sensed wind, flight altitude, and the angle between the wind and the active flight segment. FIG. 4 illustrates an alternative example that includes computing the wind-optimal airspeed for a waypoint in the flight plan. The calculation in FIG. 4 may consider a blend of sensed wind and forecast wind, the flight altitude, and the angle between the predicted wind and the predicted flight segment ending at the waypoint.

In the example illustrated in FIG. 3, the system 300 includes a performance database (PDB) 302, a flight altitude component 304, a sensed wind component 306, an angle between sensed wind and active flight segment component 308, an airspeed computation component 310, a wind-optimal airspeed target component 312, and an automatic flight control system (AFCS) 314 or mode control panel (MCP) (not illustrated separately). Each of these components 302-314 may be functional components that are implemented in software and/or by a processing system (e.g., FMS processor, etc.) or processing system. Components 302-312 may determine the most efficient flight parameters considering the current and forecasted conditions, which may be sent to the AFCS 314 to ensure that the aircraft flies along the most energy-efficient route at the optimal speed.

In some embodiments, the system 300 illustrated in FIG. 3 may include a processing system (FMS processor, etc.) configured to retrieve data about the aircraft's performance under various flight conditions from the PDB 302, determine the optimal flight altitude based on various factors (e.g., aircraft performance characteristics, flight route, weather conditions, etc.), collect real-time data regarding the wind conditions (including wind direction and magnitude), determine the angle between the direction of the wind and the direction of the active flight segment, determine the optimal airspeed based on information received from the performance database, the determined optimal flight altitude, the collected wind condition data, and/or the determined angles between sensed wind and active flight segments, generate an wind-optimal airspeed target value (e.g., the airspeed that would minimize the energy usage of the aircraft in the current wind conditions) based on the determined optimal airspeed, and use the calculated wind-optimal airspeed target to adjust the controls of the aircraft to achieve and maintain the wind-optimal airspeed and guide the aircraft along the most energy-efficient and optimal path.

The PDB 302 may store data related to the performance of the aircraft under various flight conditions, such as fuel/energy usage at different speeds, altitudes, wind conditions, etc. The flight altitude component 304 may be responsible for determining the optimal flight altitude for the flight based on a variety of factors, including weather conditions, aircraft performance characteristics, and the flight route. The sensed wind component 306 may be configured to collect real-time data about the wind conditions, including both wind direction and magnitude, for calculating the wind-optimal airspeed.

The angles between sensed wind and active flight segment component 308 may be configured to determine the angle between the direction of the wind and the direction of the active flight segment, which may be used in determining the impact of the wind on the aircraft's trajectory and speed.

In some embodiments, the airspeed computation component 310 may be configured to determine the optimal airspeed based on information received from the PDB 302, flight altitude component 304, sensed wind component 306, and angles between sensed wind and active flight segment component 308. That is, the airspeed computation component 310 may be configured to determine the optimal airspeed based on the determined flight altitude, the sensed wind condition, and the angle between the wind and the flight direction.

In some embodiments, the wind-optimal airspeed target component 312 may be configured to generate the wind-optimal airspeed target (e.g., the airspeed that would minimize the energy usage of the aircraft in the current wind conditions) based on the determined optimal airspeed. The processing system may send the calculated wind-optimal airspeed target to the AFCS 314, MCP, or pilot based on a level of automation in the aircraft, any of which may use the target speed to adjust the controls of the aircraft to achieve and maintain the airspeed.

As mentioned above, FIG. 4 illustrates an alternative example for computing the wind-optimal airspeed for a waypoint in the flight plan that includes considering a blend of sensed wind and forecast wind, the flight altitude, and the angle between the predicted wind and the predicted flight segment ending at the waypoint. Generally, in commercial aviation, the FMS applies a specific wind blending algorithm (e.g., linear wind blending model, quadratic wind blending model, etc.) that uses a mixture of sensed and forecasted wind information to predict aircraft trajectories for upcoming waypoints. In some embodiments, the wind blending algorithm may be a weighted averaging example such as Blended Wind=(Weight_sensed_wind×Sensed Wind)+(Weight_forecasted_wind×Forecasted Wind). The weights could be determined by considering factors such as the age of the last wind update, sensor quality, consistency between sensed and forecasted winds, and spatial relevance to the aircraft's current position, etc. In some embodiments, the wind blending algorithm may be a linear wind blending model such as PredictedWind=WindSensed×{1−(d/D)}+WindForecast×{d/D}, where D is the constant as a function of aircraft type, and flight mission and d is the great-circle distance from the aircraft. In some embodiments, the wind blending operations may include using any or all of Kalman filtering, Least Squares Regression, Neural Networks, Machine Learning, or any other suitable technique or formula known in the art.

For waypoints close to the aircraft, trajectory predictions may lean heavily on sensed wind, using nearly 100% of this data. As the waypoints get farther from the aircraft—for example at a distance of 200 nautical miles (nm)—the trajectory predictions may use an even blend of sensed and forecast wind. In this example, beyond the 200 nm threshold, the trajectory predictions increasingly favor forecast wind over sensed wind, until the point where the predictions are almost entirely based on forecast wind.

For low-altitude operations, the wind blending algorithm and the constant distance (D)=200 nm may be adapted to the unique characteristics and constraints of the aircraft designed for low-altitude operations for example in the urban environment. For example, the predicted wind needed to compute the wind-optimal airspeed for airspeed prediction at a waypoint a great-circle distance (d) from the aircraft may be derived using the FMS lookup routine, represented by the following formula: PredictedWind=WindSensed/{1+(d/D)\hat{ }2}+WindForecast×(d/D)\hat{ }2/{1+(d/D)\hat{ }2}

In the above equation, WindSensed is the wind speed measured by the aircraft's instruments, WindForecast is the predicted wind speed from meteorological data, and d/D is the ratio of the current waypoint distance to the constant distance D. The FMS may use the outcome (i.e., PredictedWind), for trajectory predictions and to calculate the wind-optimal airspeed at the waypoint.

With reference to FIG. 4, the system 400 may include performance database (PDB) 302, flight altitude component 304, a sensed wind component 306, a great-circle distance of a waypoint from the aircraft component 402, a wind forecast component 404, a predicted wind at a waypoint component 406, an angle between predicted wind and flight segment (Ending at waypoint) component 408, an airspeed computation component 310, a wind-optimal airspeed prediction at a waypoint component 410, and a flight plan component 412 (e.g., active, secondary, what-if, route 2, or alternate flight plan component, etc.).

In some embodiments, the system 400 illustrated in FIG. 4 may include a processing system (FMS processor, etc.) configured to retrieve data about the aircraft's performance under various flight conditions from the PDB 302, determine the optimal flight altitude based on various factors (e.g., aircraft performance characteristics, flight route, weather conditions, etc.), collect real-time data regarding the wind conditions (including wind direction and magnitude), calculate the shortest distance along the surface of the Earth between the aircraft's current position and the next waypoint, gather forecasted wind conditions along the flight plan, use the forecast data to predict the wind conditions at each waypoint in the flight plan, calculate the angle between the forecasted wind direction and the direction of the next flight segment ending at a waypoint, determine the optimal airspeed using data from the PDB, chosen flight altitude, predicted wind conditions, and angle between wind and flight direction, use the optimal airspeed and the forecasted wind conditions at the waypoint to generate a prediction of the wind-optimal airspeed when the aircraft reaches the next waypoint, and update the flight plan (e.g., including waypoints, airspeeds, and altitudes, etc.) to guide the aircraft along the most energy-efficient and optimal path.

As discussed above, the PDB 302 may store data related to the performance of the aircraft (e.g., fuel/energy usage at different speeds, altitudes, wind conditions, etc.), the flight altitude component 304 may determine the optimal flight altitude based on various factors (e.g., aircraft performance characteristics, flight route, weather conditions, etc.), and the sensed wind component 306 may collect real-time data regarding the wind conditions (e.g., wind direction and magnitude, etc.) for determining optimal airspeed and flight plan.

In some embodiments, the great-circle distance of a waypoint from the aircraft component 402 may determine the shortest distance along the surface of the earth between the aircraft's current position and the next waypoint (used for route planning, etc.). The wind forecast component 404 may determine forecasted wind conditions along the flight plan, which may be used for determining the optimal airspeed and trajectory for upcoming segments of the flight. The predicted wind at a waypoint component 406 may use the forecast data to predict the wind conditions at each waypoint in the flight plan. The angle between predicted wind and flight segment (ending at waypoint) component 408 may determine the angle between the forecasted wind direction and the direction of the next flight segment ending at a waypoint. The airspeed computation component 310 may determine the optimal airspeed using data from the PDB 302, chosen flight altitude, predicted wind conditions, and angle between wind and flight direction.

In some embodiments, the wind-optimal airspeed prediction at a waypoint component 410 may generate a prediction of the wind-optimal airspeed when the aircraft reaches the next waypoint. This prediction may consider the computed optimal airspeed and the forecasted wind conditions at the waypoint. The flight plan component 412 may use the flight plan, which includes details such as waypoints, airspeeds, and altitudes, to update the computations and predictions to guide the aircraft along the most energy-efficient and optimal path.

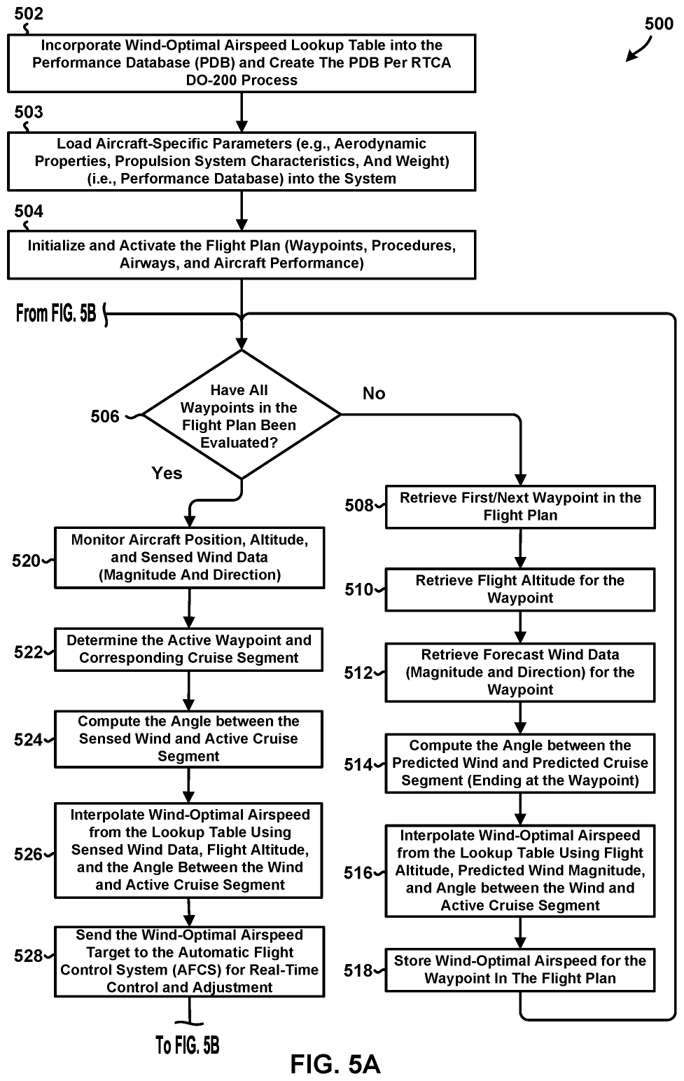

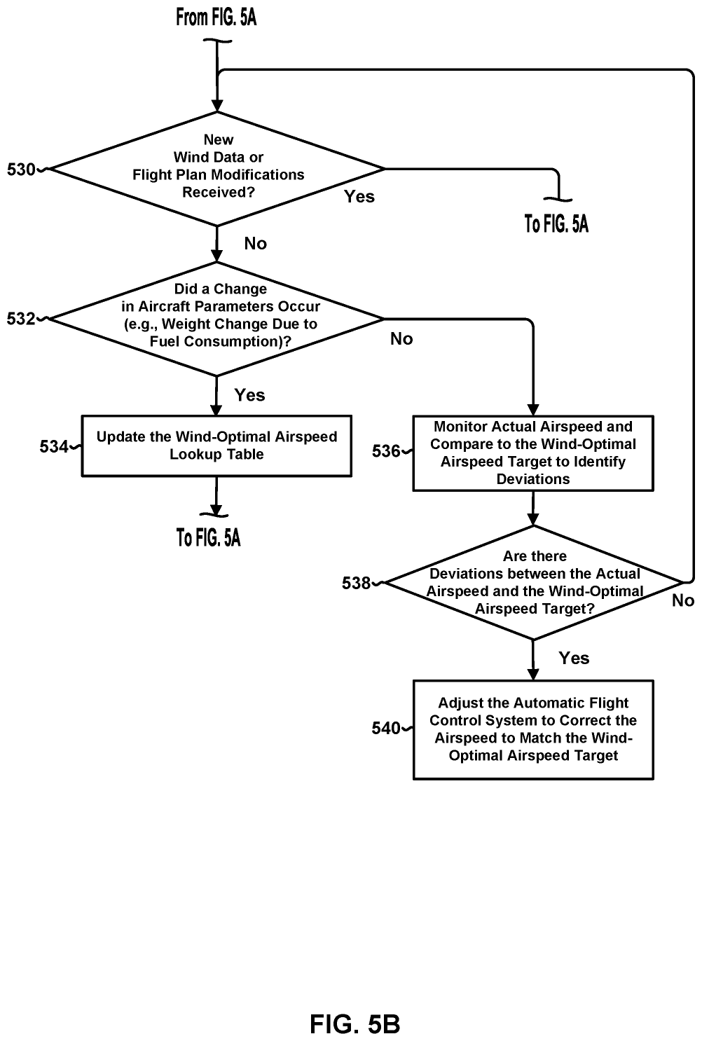

FIGS. 5A and 5B illustrate a method 500 of generating and using the wind-optimal airspeed in accordance with some embodiments. Method 500 may be performed by a processor or processing system in a computing system (e.g., which may include IMA, FMS, etc.) in an aircraft and/or in part in the GCS with some information wirelessly telemetered to the GCS from the aircraft to, for example, enable wind-optimal airspeed control for improved flight efficiency and safety.

It should be understood that in the various embodiments, any or all of the operations described with reference to blocks 502-504 and 534 may be performed during the pre-flight planning phase or post-flight phase by an Avionics Company (e.g., in an offline process) using the RTCA DO-200 process or a suitable alternative process. The RTCA DO-200 process is a set of guidelines and standards established by the Radio Technical Commission for Aeronautics (RTCA) for developing and certifying software used in avionics systems. Specifically, DO-200 provides guidance for the software aspects of airborne electronic hardware, including airborne computers, flight management systems (FMS), and other avionics components. The DO-200 documents outline the processes and procedures that need to be followed during the development, verification, and validation of avionics software. It provides guidance on various aspects of the software life cycle, including requirements analysis, design, coding, testing, and configuration management.

In block 502, the processing system (e.g., FMS processor, etc.) may incorporate a wind-optimal airspeed lookup table into the performance database (PDB) and create the PDB per RTCA DO-200 process or according to an alternative process. In block 503, the processing system may load aircraft-specific parameters (e.g., aerodynamic properties, propulsion system characteristics, and weight), i.e., the PDB into the system. In block 504, the processing system may initialize and activate the flight plan (e.g., waypoints, procedures, airways, aircraft performance, etc.). In some embodiments, the flight plan may be created with specific altitudes for each waypoint along the route during the pre-flight planning phase, which may be determined based on factors such as aircraft performance, weather conditions, air traffic control restrictions, fuel efficiency, etc. In some embodiments, the wind-optimal airspeed lookup table may include wind-optimal airspeed values that are stored directly in the lookup table as a function of aircraft type, selected speed mode, forecasted/sensed wind, determined angle, and flight altitude. In some embodiments, the wind-optimal airspeed lookup table may include wind correction factors as a function of aircraft type, selected speed mode, forecasted/sensed wind, determined angle, and flight altitude.

In determination block 506, the processing system may determine whether all of the waypoints in the flight plan have been evaluated. In response to determining that all of the waypoints in the flight plan have not been evaluated (i.e., determination block 506=“No”), in blocks 508-518 the processing system may, for each waypoint in the flight plan, retrieve flight altitude for the waypoint, retrieve forecast wind condition (magnitude and direction) for the waypoint, compute the angle between the predicted wind and predicted flight segment (ending at the waypoint), interpolate wind-optimal airspeed from the lookup table using flight altitude, predicted wind magnitude, and angle between the wind and active flight segment, and store wind-optimal airspeed for the waypoint in the flight plan.

More specifically, in block 508, the processing system may retrieve the first or next waypoint in the flight plan. In block 510, the processing system may retrieve a flight altitude parameter for the current or retrieved waypoint. The flight altitude parameter may be a pre-determined height at which the aircraft is to fly when it is in a certain phase of flight such as the cruise phase of flight, which is often the most efficient and sustained portion of the flight. The flight altitude parameter may be predefined in the flight plan for each waypoint in the pre-flight planning phase. For example, the processing system may retrieve the flight altitude parameter by using the specific waypoint to query the flight plan loaded into the FMS and/or stored in memory.

In block 512, the processing system may retrieve forecast wind condition (magnitude and direction) for the waypoint. The processing system may retrieve the forecast wind condition from any of a variety of sources, such as an aviation meteorological service, an on-board weather radar system, satellite data, aircraft-based observations, weather models, information broadcast from the ground, etc. In block 514, the processing system may compute the angle between the predicted wind and the predicted flight segment (ending at the waypoint). In some embodiments, the processing system may determine the angle using the known wind direction and the direction of the flight segment. For example, the processing system may determine a predicted wind direction by using the forecasted wind condition retrieved for the waypoint to determine the direction from which the wind is coming (e.g., in degrees relative to True North, etc.). The processing system may determine the flight segment direction based on the geographical locations of the waypoints that define the segment. The processing system may determine the angle as the absolute difference between the flight segment direction and the predicted wind direction. In some embodiments, the processing system may update the determined angle to account for the circular nature of direction measurements (for example, the angle between a wind from 350° and a route to 10° should be 20°, not 340°, etc.).

The processing system may use the determined angle in further calculations, such as to determine wind-optimal airspeed for the waypoint. The determined angle may affect the computations regarding the impact of the wind on the aircraft's speed over the ground. Generally, a tailwind (wind from behind, roughly the same direction as the route) may increase groundspeed, a headwind (wind from ahead, roughly opposite the route) may decrease groundspeed, and a crosswind (wind from the side, roughly 90° to the route) may require the aircraft to adjust its heading to maintain the flight along the planned route, which may result in reducing the ground speed along the route of flight.

In block 516, the processing system may interpolate the wind-optimal airspeed for the waypoint from the lookup table based on the flight altitude, the predicted wind magnitude, and the angle between the wind and active flight segment. For example, the processing system may identify lookup table entries that are closest to (e.g., just below and just above) the current conditions (e.g., flight altitude, predicted wind magnitude, and angle between the wind and active flight segment), and apply them to a mathematical interpolation function that generates an airspeed estimate for the current conditions based on the optimal airspeeds for the identified conditions. That is, the processing system may use an interpolation function to generate a wind-optimal airspeed value that identifies the most energy-efficient airspeed for the current conditions that will allow the aircraft to make the most progress toward its destination for the least amount of energy, considering both the need to overcome wind resistance and the operating efficiency of the aircraft's propulsion system. In block 518, the processing system may store the wind-optimal airspeed for the waypoint in the flight plan.

After storing the wind-optimal airspeed for the waypoint, the processing system may again determine whether all of the waypoints in the flight plan have been evaluated in determination block 506. In response to determining that all of the waypoints in the flight plan have been evaluated (i.e., determination block 506=“Yes”), the processing system may monitor aircraft position, altitude, and sensed wind condition (magnitude and direction) in block 520. The processing system may monitor these values, conditions, or data points for several different reasons. For example, by tracking the aircraft's position, the processing system may assess how far the aircraft has progressed along its planned route, how close it is to its next waypoint or destination, manage various aspects of the flight (e.g., the timing of changes in course, speed, or altitude, etc.), and/or provide updates to the pilots, air traffic control, and/or onboard navigation systems.

In addition, the actual wind conditions experienced by the aircraft may differ from the forecasted values used to plan the flight. By continually monitoring the sensed wind condition, the processing system may adjust the flight plan in real-time to account for the differences. For example, if the wind is stronger or from a different direction than expected, the processing system may adjust the aircraft's speed or heading to maintain the planned route and schedule. Similarly, the aircraft's altitude may affect its performance, including its speed, fuel efficiency, and ability to handle windy conditions. By tracking the aircraft's altitude, the processing system may ensure that the aircraft maintains its planned altitude and adjust the flight plan if the aircraft needs to climb or descend due to weather conditions, air traffic control instructions, or other factors. Further, as the aircraft approaches a waypoint, the processing system may prepare for any changes in direction, speed, or altitude associated with that waypoint. For example, if the flight plan calls for a change in course at a waypoint, the processing system may begin adjusting the aircraft's heading in advance to ensure a smooth turn.

In block 522, the processing system may determine the active waypoint and corresponding flight segment. In block 524, the processing system may compute the angle between the sensed wind and the active flight segment. The processing system may use the computed angle to determine whether the wind is a headwind, tailwind, or crosswind. For example, if the angle is a small value, it may suggest a headwind or tailwind depending on the direction. If the angle is a large value (e.g., close to 90 degrees, etc.), it may suggest a crosswind that could push the aircraft off its intended course. By computing this angle, the processing system may adjust the aircraft's airspeed and heading to account for these wind effects, ensuring the aircraft follows its intended flight plan as closely as possible and maximizing its energy efficiency. For example, it may increase the airspeed to counter a headwind or decrease it to take advantage of a tailwind.

In block 526, the processing system may interpolate wind-optimal airspeed from the lookup table using sensed wind condition, flight altitude, and the angle between the wind and active flight segment. That is, the lookup table in the PDB may include a precomputed set of airspeed values for various combinations of sensed wind condition, flight altitude, and angle between the wind and active flight segment. These airspeed values may have been calculated based on the aircraft's performance characteristics and aerodynamic modeling. By interpolating values from this table, the processing system may quickly and accurately determine the wind-optimal airspeed in real-time, thereby enhancing the flight's efficiency and safety. Said another way, these operations may allow the processing system to determine the most efficient speed more accurately for the aircraft under the current flight conditions. In block 528, the processing system may send the wind-optimal airspeed target to the automatic flight control system (AFCS) for real-time control.

With reference to FIG. 5B, in determination block 530, the processing system may determine whether new wind conditions or flight plan modifications have been received. As mentioned above, wind conditions may greatly affect the aircraft's performance. If new wind condition is received (e.g., from an updated weather report, the aircraft's onboard weather sensing system, broadcast from the ground, etc.), the processor system may need to reconsider the optimal airspeed and/or adjust the flight trajectory to maintain efficiency and safety. Likewise, changes to the flight plan (e.g., new waypoints, altered timing, etc.) may change the optimal flight altitude, route, and/or airspeed. By continuously checking for new wind conditions and flight plan modifications, the processing system may adapt to changing conditions in real-time, optimizing the aircraft's performance, enhancing fuel efficiency, and enhancing safety.

In response to determining that new wind conditions or flight plan modifications have been received (i.e., determination block 530=“Yes”), the processing system may again determine whether all of the waypoints in the flight plan have been evaluated in determination block 506. That is, new wind conditions or flight plan modifications may affect the previously calculated wind-optimal airspeeds and trajectory for the remaining waypoints. By going back to determination block 506 and re-evaluating the waypoints, the processing system may help ensure that the flight plan stays up to date with the latest information and that the aircraft continues to operate in the safest and most efficient manner.

In response to determining that new wind condition or flight plan modifications have not been received (i.e., determination block 530=“No”), the processing system may determine whether there has been a change in aircraft parameters (e.g., a weight change due to fuel consumption, etc.) in determination block 532. As mentioned above, aircraft performance is impacted by factors such as weight, speed, and altitude. For example, as fuel is consumed during a flight, the aircraft becomes lighter, which may affect its climb rate, cruise speed, and fuel efficiency. These changes may reduce the performance, accuracy, or efficiency of the previously calculated airspeed values and/or flight trajectories. Accordingly, the processing system may determine whether there have been changes in other factors that might impact the aircraft's performance and flight plan. If there are changes in the aircraft parameters, the system might need to recompute the wind-optimal airspeeds and the trajectory for the remaining waypoints to ensure continued efficiency and safety of the flight.

In response to determining that there has been a change in aircraft parameters (i.e., determination block 532=“Yes”), the processing system may update the wind-optimal airspeed lookup table and again determine whether all of the waypoints in the flight plan have been evaluated in determination block 506. That is, if there has been a change in aircraft parameters (e.g., change in weight due to fuel consumption, etc.), the wind-optimal airspeed for the aircraft that minimizes energy consumption could potentially change as well. This is because aircraft parameters directly influence the aerodynamic performance of the aircraft, which may in turn affect its fuel efficiency and wind-optimal airspeed. Accordingly, upon determining that there has been a change in aircraft parameters, the processing system may recalculate the wind-optimal airspeeds that should be followed to minimize energy consumption based on the updated aircraft parameters and update the wind-optimal airspeed lookup table to account for these changes.

In response to determining that there has not been a change in aircraft parameters (i.e., determination block 532=“No”), the processing system may monitor actual airspeed (e.g., the speed at which the aircraft is currently flying) and compare it to the wind-optimal airspeed target in block 536. In determination block 538, the processing system may determine whether there are deviations between the actual airspeed and the wind-optimal airspeed target. In block 540, the processing system may adjust the automatic flight control system to correct the airspeed to match the wind-optimal airspeed target in response to determining that there are deviations between the actual airspeed and the wind-optimal airspeed target.

That is, the actual airspeed may be influenced by a number of factors, including the power settings applied by the pilot or autopilot, the aircraft's weight, the aircraft's altitude, and atmospheric conditions such as wind speed and direction. In some embodiments, the processing system may compare this actual airspeed to the wind-optimal airspeed target (e.g., the airspeed calculated as most efficient considering the current wind conditions), the aircraft's performance capabilities, and its flight trajectory, use the comparison results to identify deviations from the optimal airspeed that could lead to increased energy consumption, and make adjustments to the airspeed or trajectory based on the identified deviations.

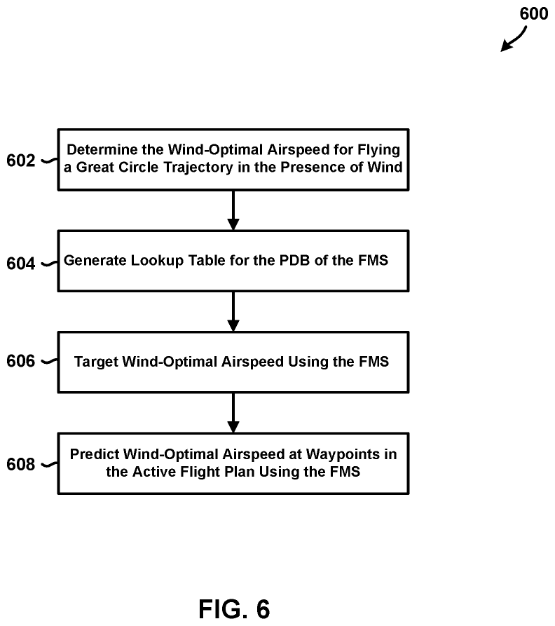

FIG. 6 illustrates a method 600 of generating a predicted wind-optimal airspeed in accordance with some embodiments. Method 600 may be performed by a processor or processing system in a computing system (e.g., which may include IMA, FMS, etc.) in an aircraft and/or in part in the GCS. In block 602, the processing system may determine the wind-optimal airspeed for flying a great circle trajectory in the presence of wind. In block 604, the processing system may generate a lookup table for the PDB of the FMS. In block 606, the processing system may target wind-optimal airspeed using the FMS. In block 608, the processing system may predict wind-optimal airspeed at waypoints in the flight plan using the FMS.

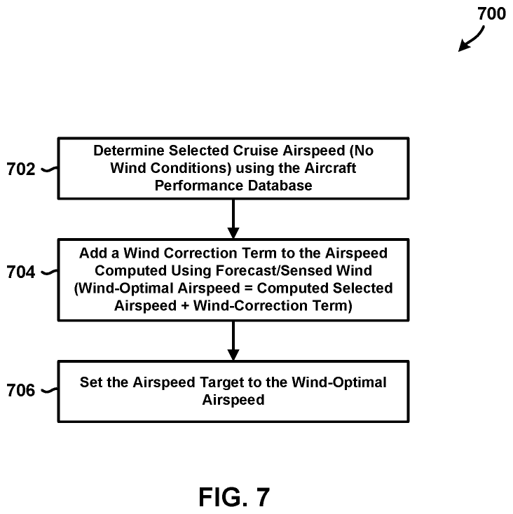

FIG. 7 illustrates a method 700 of setting an airspeed target in accordance with some embodiments. Method 700 may be performed by a processor or processing system in a computing system (e.g., which may include IMA, FMS, etc.) in an aircraft and/or in part in the GCS. In block 702, the processing system may determine a selected flight airspeed (no wind conditions) using the aircraft performance database. In block 704, the processing system may add a wind correction factor to the airspeed computed using forecast/sensed wind (e.g., Wind-optimal airspeed=computed selected airspeed+wind-correction factor). In block 706, the processing system may set the airspeed target to the wind-optimal airspeed.

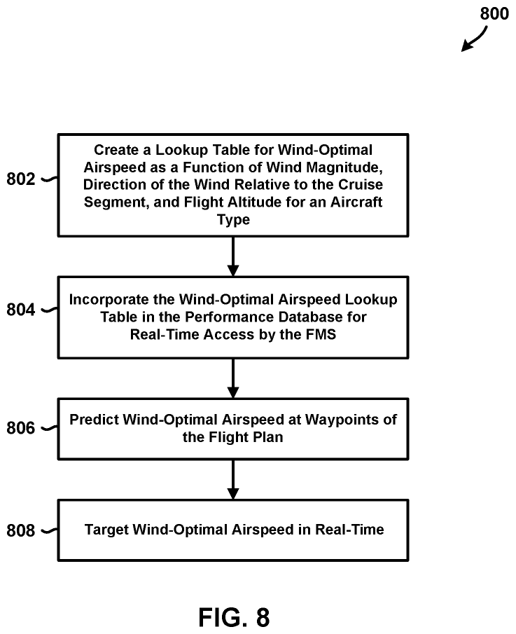

FIG. 8 illustrates a method 800 of creating and using a lookup table for wind-optimal airspeed in accordance with some embodiments. Method 800 may be performed by a processor or processing system in a computing system (e.g., which may include IMA, FMS, etc.) in an aircraft and/or in part in the GCS. In block 802, the processing system may create a lookup table for wind-optimal airspeed as a function of wind magnitude, direction of the wind relative to the flight segment, and flight altitude for an aircraft type. In block 804, the processing system may incorporate the wind-optimal airspeed lookup table in the PDB for real-time access by the FMS. This may allow the FMS to access and use the optimal airspeed values during the aircraft's flight in real-time. In block 806, the processing system may predict wind-optimal airspeed at waypoints of the flight plan. For example, for each waypoint, the processing system may calculate the most efficient airspeed considering predicted wind conditions and the aircraft's altitude. In block 808, the processing system may target wind-optimal airspeed in real-time. Thus, as the aircraft flies its route, the processing system may continuously update and try to maintain the optimal airspeed determined from the lookup table. This may be accomplished automatically through the aircraft's automatic control system, which may include flight control system, autothrottle, and/or autopilot. The processing system may also provide the speed recommendations (wind-optimal airspeed targets) to the pilots to manually adjust the airspeed.

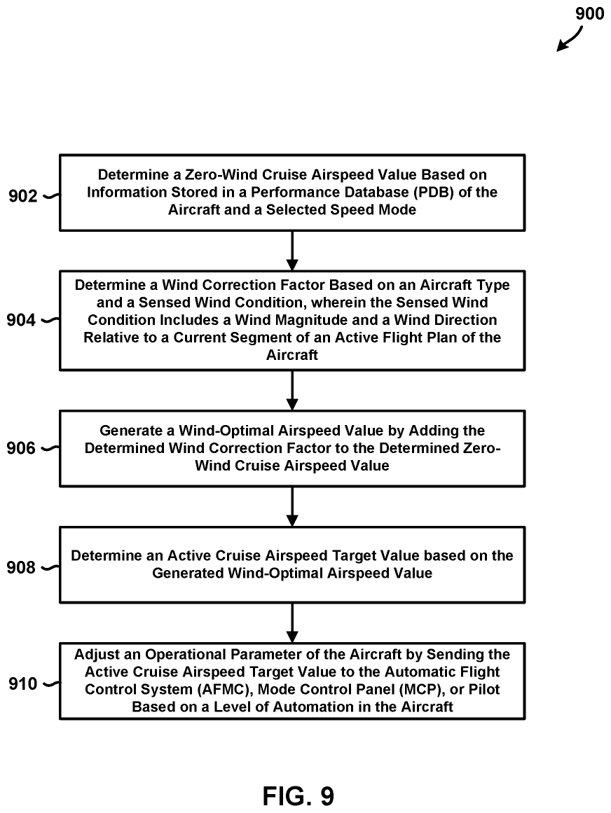

FIG. 9 illustrates a method 900 of operating an aircraft in accordance with some embodiments. Method 900 may be performed by a processor or processing system in a computing system (e.g., which may include IMA, FMS, etc.) in the aircraft and/or in part in GCS.

In block 902, the processing system may determine a zero-wind airspeed value based on information stored in the aircraft's performance database (PDB) and a selected speed mode. For example, the processing system may determine that the zero-wind airspeed value is 100 knots (185 km/h), 200 knots (370 km/h), etc.

In block 904, the processing system may determine a wind correction factor based on an aircraft type, and a sensed wind condition. In some embodiments, the processing system may determine the wind correction factor based on any or all of a variety of parameters, such as forecasted wind condition, sensed wind condition, flight altitude, wind magnitude and direction of the wind relative to a current segment of a flight plan of the aircraft, etc. In some embodiments, the wind correction factor may be represented by a single numerical value. In some embodiments, the wind correction factor may be represented by a combination of adjustments made to the aircraft's planned airspeed and heading to account for the effects of wind.

In block 906, the processing system may generate a wind-optimal airspeed value by adding the determined wind correction factor to the determined zero-wind airspeed value. In some embodiments, the processing system may generate the wind-optimal airspeed value for flying a segment of the flight plan in the presence of wind.

In block 908, the processing system may determine an active airspeed target value based on the generated wind-optimal airspeed value. In block 910, the processing system may adjust one or more operational parameters of the aircraft by sending the active airspeed target value to the automatic flight control system (AFCS), mode control panel (MCP), or pilot based on a level of automation in the aircraft. For example, in some embodiments, the processing system may adjust the current airspeed of the aircraft based on the sensed wind condition to maintain an airspeed for the aircraft that reduces energy consumption or increases an operational range of the aircraft.

In some embodiments, method 900 may further include creating a wind-optimal airspeed value look-up table as a function of aircraft type, wind magnitude and wind direction relative to a planned segment of the flight plan associated with a waypoint, and a flight altitude, and incorporating the wind-optimal airspeed value look-up table to the PDB using RTCA DO-200 or an alternative process. In some embodiments, method 900 may further include identifying a sequence of waypoints in the flight plan of the aircraft and generating a predicted wind-optimal airspeed value for each waypoint in the identified sequence of waypoints. For example, the processing system may generate a predicted wind-optimal airspeed value for each waypoint in the identified sequence of waypoints by generating values that estimate an airspeed at each waypoint based on a forecasted wind condition, a sensed wind condition, aircraft performance data, and the flight plan.

In some embodiments, the flight plan may include a sequence of waypoints, airways, flight levels, airspeeds, and departure and arrival procedures for an aircraft to fly from the origin to the destination. In some embodiments, the aircraft performance data may include any or all of economy climb speed data (all-engine and one engine inoperative), economy cruise speed data (all-engine and one engine inoperative), economy descent speed data (all-engine and one engine inoperative), drift-down speed data, hold speed data, maximum endurance speed data, long range cruise (LRC) speed data, maximum angle climb speed data, maximum rate of climb speed data, flap/slat/gear placard speeds, maximum altitude (all engine and one engine inoperative), takeoff time, fuel, battery state-of-charge, distance data, go-around time, alternate (alternative) flight plan time, optimum altitude/optimum step weight data, relationship between fuel weight/C.G., takeoff/approach data, data to compute V1, VR and V2, approach speed data, and/or climb-out speed data.

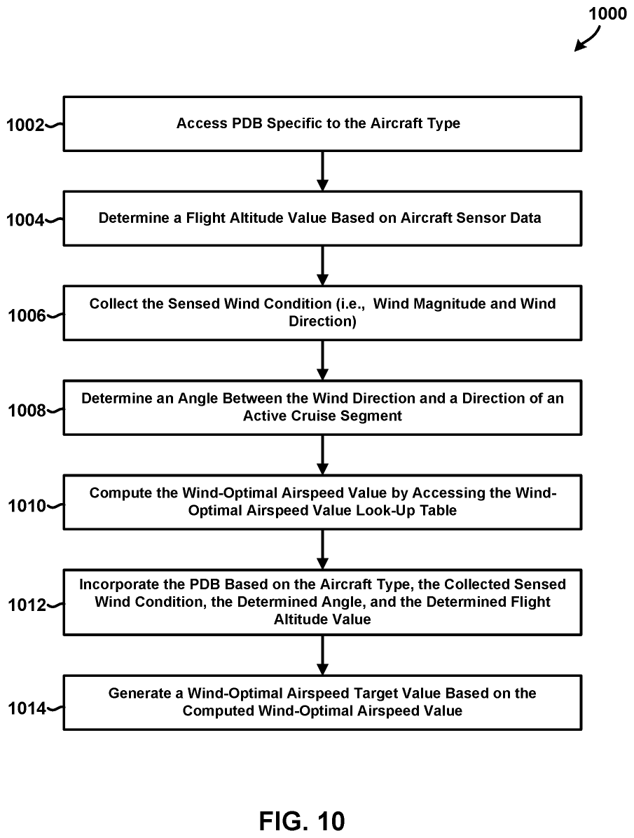

FIG. 10 illustrates another method 1000 of operating an aircraft in accordance with some embodiments. Method 1000 may be performed by a processor or processing system in a computing system (e.g., which may include IMA, FMS, etc.) in the aircraft and/or in part in the GCS. In some embodiments, method 1000 may be performed as part of method 900 above to control the operations of the aircraft.

In block 1002, the processing system may access a PDB specific to the aircraft type. The processing system may identify the aircraft type based on information manually entered by the pilot or may be automatically recognized based on pre-configured data or systems within the aircraft.

In block 1004, the processing system may determine a flight altitude value based on aircraft sensor data. As discussed above, the flight altitude value may identify the altitude at which the aircraft travels during a portion of the flight. The processing system may determine the optimal flight altitude based on various factors, such as aircraft performance characteristics, flight route, and weather conditions. The aircraft sensor data may include information identifying the aircraft weight, outside air temperature, pressure altitude, air speed, etc.

In block 1006, the processing system may collect the sensed wind condition (i.e., wind magnitude and wind direction). The processing system may collect the sensed wind condition based on a combination of onboard instruments and information received from external sources. For example, the aircraft may include an airspeed indicator that measures the speed of the aircraft relative to the air around it and a heading indicator that measures the direction the aircraft is pointed. The processing system may calculate the wind speed and direction by comparing the aircraft's airspeed and heading (which the aircraft should be flying if there were no wind) to its ground speed and track (the actual speed and direction the aircraft is moving with respect to the ground). The aircraft may also include a weather radar that provides information about wind conditions and/or may receive information about wind conditions from satellite and ground-based weather reporting systems.

In block 1008, the processing system may determine an angle between the wind direction and a direction of an active flight segment. In block 1010, the processing system may compute the wind-optimal airspeed value by accessing the wind-optimal airspeed value look-up table. In block 1012, the processing system may incorporate the PDB based on the aircraft type, the collected sensed wind condition, the determined angle, and the determined flight altitude value.

In block 1014, the processing system may generate a wind-optimal airspeed target value based on the computed wind-optimal airspeed value. The processing system may then adjust the operational parameter of the aircraft (e.g., as part of block 910, etc.) by using the generated Wind-Optimal Airspeed Target value to adjust the controls of the aircraft or provide advisories to the pilot to achieve or maintain the wind-optimal airspeed and guide the aircraft along an energy-efficient path.

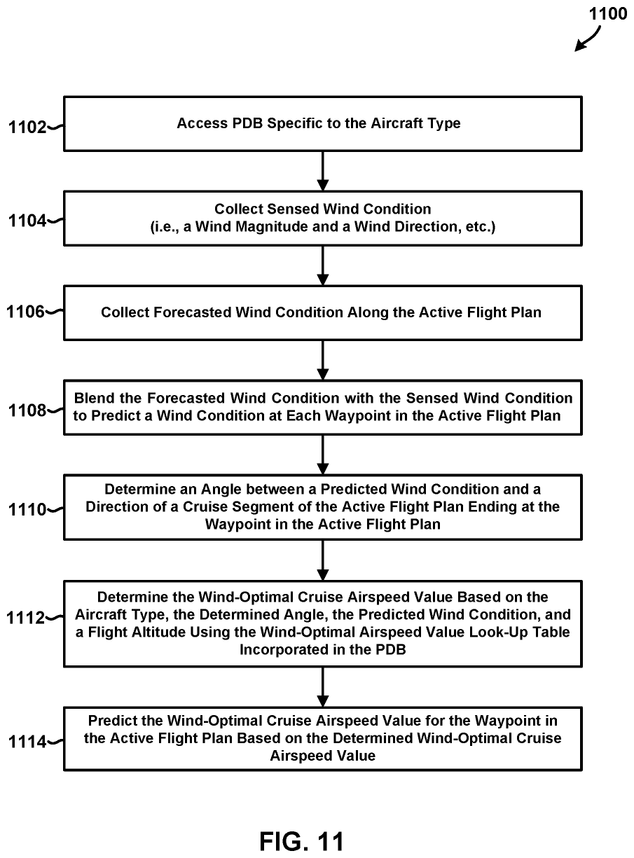

FIG. 11 illustrates another method 1100 of operating an aircraft in accordance with some embodiments. Method 1100 may be performed by a processor or processing system in a computing system (e.g., which may include IMA, FMS, etc.) in the aircraft or in part in the GCS. In some embodiments, method 1100 may be performed as part of method 900 above to control the operations of the aircraft.

In blocks 1102 and 1104, the processing system may access PDB specific to the aircraft type and collect sensed wind condition (as discussed above with reference to blocks 1002 and 1004).

In block 1106, the processing system may collect forecasted wind condition along the flight plan.

In block 1108, the processing system may blend the forecasted wind condition with the sensed wind condition to predict a wind condition at each waypoint in the flight plan.

In block 1110, the processing system may determine an angle between a predicted wind condition and a direction of a segment of the flight plan ending at the waypoint in the flight plan.

In block 1112, the processing system may determine the wind-optimal airspeed value based on the aircraft type (or model, registration number, etc.) the determined angle, the predicted wind condition, and a flight altitude using the wind-optimal airspeed value look-up table incorporated in the PDB.

In block 1114, the processing system may predict the wind-optimal airspeed value for the waypoint in the flight plan based on the determined wind-optimal airspeed value.

The processors and processing systems discussed in this application may include one or more of any programmable microprocessor, microcomputer or multiple processor chip or chips that can be configured by software instructions (applications) to perform a variety of functions, including the functions of the various embodiments described above. In some devices, multiple processors may be provided, such as one processor dedicated to wireless communication functions and one processor dedicated to running other applications. Typically, software applications may be stored in the internal memory before application software is accessed and loaded into the processors. The processing system may include internal memory sufficient to store the application software instructions. In many devices, the internal memory may be a volatile or nonvolatile memory, such as flash memory, or a mixture of both. For the purposes of this description, a general reference to memory refers to memory accessible by the processors including internal memory or removable memory plugged into the device and memory within the processors themselves. Additionally, as used herein, any reference to a memory may be a reference to a memory storage and the terms may be used interchangeably.

A number of different types of memories and memory technologies are available or contemplated in the future, any or all of which may be included and used in systems and computing devices that implement the various embodiments. Such memory technologies/types may include non-volatile random-access memories (NVRAM) such as Magnetoresistive RAM (M-RAM), resistive random access memory (ReRAM or RRAM), phase-change random-access memory (PC-RAM, PRAM or PCM), ferroelectric RAM (F-RAM), spin-transfer torque magnetoresistive random-access memory (STT-MRAM), and three-dimensional cross point (3D-XPOINT) memory. Such memory technologies/types may also include non-volatile or read-only memory (ROM) technologies, such as programmable read-only memory (PROM), field programmable read-only memory (FPROM), one-time programmable non-volatile memory (OTP NVM). Such memory technologies/types may further include volatile random-access memory (RAM) technologies, such as dynamic random-access memory (DRAM), double data rate (DDR) synchronous dynamic random-access memory (DDR SDRAM), static random-access memory (SRAM), and pseudostatic random-access memory (PSRAM). Systems and computing devices that implement the various embodiments may also include or use electronic (solid-state) non-volatile computer storage mediums, such as FLASH memory. Each of the above-mentioned memory technologies include, for example, elements suitable for storing instructions, programs, control signals, and/or data for use in or by a robotic device's processing device, system on chip (SOC) or other electronic component. Any references to terminology and/or technical details related to an individual type of memory, interface, standard or memory technology are for illustrative purposes only, and not intended to limit the scope of the claims to a particular memory system or technology unless specifically recited in the claim language.

Implementation examples are described in the following paragraphs. While some of the following implementation examples are described in terms of example methods, further example implementations may include: the example methods discussed in the following paragraphs implemented by a computing device including a processor configured with processor-executable instructions to perform operations of the methods of the following implementation examples; the example methods discussed in the following paragraphs implemented by a computing device including means for performing functions of the methods of the following implementation examples; and the example methods discussed in the following paragraphs may be implemented as a non-transitory processor-readable storage medium having stored thereon processor-executable instructions configured to cause a processor of a computing device to perform the operations of the methods of the following implementation examples.

Example 1: A method of operating an aircraft, including determining a zero-wind airspeed value based on information stored in a performance database (PDB) of the aircraft and a selected speed mode, determining a wind correction factor based on an aircraft type, and a sensed wind condition, in which the sensed wind condition includes a wind magnitude and a wind direction relative to a current segment of a flight plan of the aircraft, generating a wind-optimal airspeed value by adding the determined wind correction factor to the determined zero-wind airspeed value, determining an active airspeed target value based on the generated wind-optimal airspeed value, and adjusting an operational parameter of the aircraft by sending the active airspeed target value to the automatic flight control system (AFCS), mode control panel (MCP), or pilot based on a level of automation in the aircraft.

Example 2: The method of example 1, further including creating a wind-optimal airspeed value look-up table as a function of aircraft type, a wind magnitude and a wind direction relative to a planned segment of the flight plan associated with a waypoint, and a flight altitude, and incorporating the wind-optimal airspeed value look-up table to the PDB using RTCA or an alternative process.

Example 3: The method of examples 1 or 2, further including identifying a sequence of waypoints in the flight plan of the aircraft, and generating a predicted wind-optimal airspeed value for each waypoint in the identified sequence of waypoints.

Example 4: The method of any of the examples 1-3, in which generating the predicted wind-optimal airspeed value for each of the identified sequence of waypoints includes generating values that estimate an airspeed at each waypoint based on the following parameters a forecasted wind condition, the sensed wind condition, aircraft performance data, and the flight plan.

Example 5: The method of any of the examples 1-4, in which adjusting the operational parameter of the aircraft by sending the active airspeed target value to the AFCS, the MCP, or the pilot based on the level of automation in the aircraft includes adjusting a current airspeed of the aircraft based on the sensed wind condition to maintain an airspeed for the aircraft that reduces energy consumption or increases an operational range of the aircraft.

Example 6: The method of any of the examples 1-5, in which generating the wind-optimal airspeed value by adding the determined wind correction factor to the determined zero-wind airspeed value includes generating the wind-optimal airspeed value for flying a segment of the flight plan in the presence of wind.

Example 7: The method of any of the examples 1-6, further including accessing PDB specific to the aircraft type, determining a flight altitude value based on aircraft sensor data, collecting the sensed wind condition that includes the wind magnitude and the wind direction, determining an angle between the wind direction and a direction of an active flight segment, computing the wind-optimal airspeed value by accessing the wind-optimal airspeed value look-up table incorporated in the PDB based on the aircraft type, the collected sensed wind condition, the determined angle, and the determined flight altitude value, and generating a wind-optimal airspeed target value based on the computed wind-optimal airspeed value.

Example 8: The method of example 7, in which adjusting the operational parameter of the aircraft by sending the active airspeed target value to the AFCS, the MCP, or the pilot based on the level of automation in the aircraft further includes using the generated wind-optimal airspeed target value to adjust the controls of the aircraft or provide advisories to the pilot to achieve or maintain the wind-optimal airspeed and guide the aircraft along an energy-efficient path.

Example 9: The method of any of the examples 1-6, further including accessing PDB specific to the aircraft type, collecting the sensed wind condition that includes the wind magnitude and the wind direction, determining a great-circle distance between a current position of the aircraft and a waypoint in the flight plan, collecting a forecasted wind condition along the flight plan, blending the forecasted wind condition with the sensed wind condition to predict a wind condition at each waypoint in the flight plan, determining an angle between a predicted wind condition and a direction of a segment of the flight plan ending at the waypoint in the flight plan, determining the wind-optimal airspeed value based on the aircraft type, the determined angle, the predicted wind condition, and a flight altitude using the wind-optimal airspeed value look-up table incorporated in the PDB, and predicting the wind-optimal airspeed value for the waypoint in the flight plan based on the determined wind-optimal airspeed value.

Example 10: The method of example 9, in which adjusting the operational parameter of the aircraft by sending the active airspeed target value to the AFCS, the MCP, or the pilot based on the level of automation in the aircraft further includes updating the flight plan based on the predicted wind-optimal airspeed value.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order, including in parallel. Words such as “thereafter,” “then,” “next,” etc., are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, an application specific integrated circuit (ASIC), programmable logic device (PLD), a field programmable gate array (FPGA) or other programmable logic device, discrete gate or transistor logic, discrete hardware components, or any combination thereof designed to perform the functions described herein (e.g., for inclusion in aircraft systems and equipment per the official guidance materials—DO-254 and DO-297, etc.). A general-purpose processor may be a multiprocessor, but, in the alternative, the processor may be any conventional processor, controller, microcontroller, or state machine. A processor may also be implemented as a combination of computing devices, e.g., a combination of a DSP and a multiprocessor, a plurality of multiprocessors, one or more multiprocessors in conjunction with a DSP core, or any other such configuration. Alternatively, some steps or methods may be performed by circuitry that is specific to a given function.

In one or more exemplary embodiments, the functions described may be implemented in hardware, software, firmware, or any combination thereof. If implemented in software, the functions may be stored as one or more processor-executable instructions or code on a non-transitory computer-readable storage medium or non-transitory processor-readable storage medium. The steps of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the claims are not intended to be limited to the embodiments shown herein but are to be accorded the widest scope consistent with the following claims and the principles and novel features disclosed herein.

What is claimed is:

1. A method of operating an aircraft, comprising:
determining a zero-wind airspeed value based on information stored in a performance database (PDB) of the aircraft and a selected speed mode;
determining a wind correction factor based on an aircraft type, and a sensed wind condition, wherein the sensed wind condition includes a wind magnitude and a wind direction relative to a current segment of a flight plan of the aircraft;
generating a wind-optimal airspeed value by adding the determined wind correction factor to the determined zero-wind airspeed value;
determining an active airspeed target value based on the generated wind-optimal airspeed value; and
adjusting an operational parameter of the aircraft by sending the active airspeed target value to the automatic flight control system (AFCS), mode control panel (MCP), or pilot based on a level of automation in the aircraft.

2. The method of claim 1, further comprising:
creating a wind-optimal airspeed value look-up table as a function of aircraft type, a wind magnitude and a wind direction relative to a planned segment of the flight plan associated with a waypoint, and a flight altitude; and
incorporating the wind-optimal airspeed value look-up table to the PDB using RTCA DO-200 or an alternative process.

3. The method of claim 1, further comprising:
identifying a sequence of waypoints in the flight plan of the aircraft; and
generating a predicted wind-optimal airspeed value for each waypoint in the identified sequence of waypoints.

4. The method of claim 3, wherein generating the predicted wind-optimal airspeed value for each of the identified sequence of waypoints comprises generating values that estimate an airspeed at each waypoint based on the following parameters:
a forecasted wind condition;
the sensed wind condition;
aircraft performance data; and
the flight plan.

5. The method of claim 1, wherein adjusting the operational parameter of the aircraft by sending the active airspeed target value to the AFCS, the MCP, or the pilot based on the level of automation in the aircraft comprises adjusting a current airspeed of the aircraft based on the sensed wind condition to maintain an airspeed for the aircraft that reduces energy consumption or increases an operational range of the aircraft.

6. The method of claim 1, wherein generating the wind-optimal airspeed value by adding the determined wind correction factor to the determined zero-wind airspeed value comprises generating the wind-optimal airspeed value for flying a segment of the flight plan in the presence of wind.

7. The method of claim 1, further comprising
accessing PDB specific to the aircraft type;
determining a flight altitude value based on aircraft sensor data;
collecting the sensed wind condition that includes the wind magnitude and the wind direction;
determining an angle between the wind direction and a direction of an active flight segment;
computing the wind-optimal airspeed value by accessing the wind-optimal airspeed value look-up table incorporated in the PDB based on the aircraft type, the collected sensed wind condition, the determined angle, and the determined flight altitude value; and
generating a wind-optimal airspeed target value based on the computed wind-optimal airspeed value.

8. The method of claim 7, wherein adjusting the operational parameter of the aircraft by sending the active airspeed target value to the AFCS, the MCP, or the pilot based on the level of automation in the aircraft further comprises using the generated wind-optimal airspeed target value to adjust the controls of the aircraft or provide advisories to the pilot to achieve or maintain the wind-optimal airspeed and guide the aircraft along an energy-efficient path.

9. The method of claim 1, further comprising:
accessing PDB specific to the aircraft type;
collecting the sensed wind condition that includes the wind magnitude and the wind direction;
determining a great-circle distance between a current position of the aircraft and a waypoint in the flight plan;
collecting a forecasted wind condition along the flight plan;
blending the forecasted wind condition with the sensed wind condition to predict a wind condition at each waypoint in the flight plan;
determining an angle between a predicted wind condition and a direction of a segment of the flight plan ending at the waypoint in the flight plan;
determining the wind-optimal airspeed value based on the aircraft type, the determined angle, the predicted wind condition, and a flight altitude using the wind-optimal airspeed value look-up table incorporated in the PDB; and
predicting the wind-optimal airspeed value for the waypoint in the flight plan based on the determined wind-optimal airspeed value.

10. The method of claim 9, wherein adjusting the operational parameter of the aircraft by sending the active airspeed target value to the AFCS, the MCP, or the pilot based on the level of automation in the aircraft further comprises updating the flight plan based on the predicted wind-optimal airspeed value.

11. A computing system, comprising:
a processing system configured to perform operations comprising:
determining a zero-wind airspeed value based on information stored in a performance database (PDB) of an aircraft and a selected speed mode;
determining a wind correction factor based on an aircraft type, and a sensed wind condition, wherein the sensed wind condition includes a wind magnitude and a wind direction relative to a current segment of a flight plan of the aircraft;
generating a wind-optimal airspeed value by adding the determined wind correction factor to the determined zero-wind airspeed value;
determining an active airspeed target value based on the generated wind-optimal airspeed value; and
adjusting an operational parameter of the aircraft by sending the active airspeed target value to the automatic flight control system (AFCS), mode control panel (MCP), or pilot based on a level of automation in the aircraft.

12. The computing system of claim 11, wherein the processing system is configured to perform operations further comprising:
creating a wind-optimal airspeed value look-up table as a function of aircraft type, a wind magnitude and a wind direction relative to a planned segment of the flight plan associated with a waypoint, and a flight altitude; and
incorporating the wind-optimal airspeed value look-up table to the PDB using RTCA DO-200 or an alternative process.

13. The computing system of claim 11, wherein the processing system is configured to perform operations further comprising:
identifying a sequence of waypoints in the flight plan of the aircraft; and
generating a predicted wind-optimal airspeed value for each waypoint in the identified sequence of waypoints.

14. The computing system of claim 13, wherein the processing system is configured to perform operations such that generating the predicted wind-optimal airspeed value for each of the identified sequence of waypoints comprises generating values that estimate an airspeed at each waypoint based on the following parameters:
a forecasted wind condition;
the sensed wind condition;
aircraft performance data; and
the flight plan.

15. The computing system of claim 11, wherein the processing system is configured to perform operations such that adjusting the operational parameter of the aircraft by sending the active airspeed target value to the AFCS, the MCP, or the pilot based on the level of automation in the aircraft comprises adjusting a current airspeed of the aircraft based on the sensed wind condition to maintain an airspeed for the aircraft that reduces energy consumption or increases an operational range of the aircraft.

16. The computing system of claim 11, wherein the processing system is configured to perform operations such that generating the wind-optimal airspeed value by adding the determined wind correction factor to the determined zero-wind airspeed value comprises generating the wind-optimal airspeed value for flying a segment of the flight plan in the presence of wind.

17. The computing system of claim 11, wherein:
the processing system is configured to perform operations further comprising:
accessing PDB specific to the aircraft type;
determining a flight altitude value based on aircraft sensor data;
collecting the sensed wind condition that includes the wind magnitude and the wind direction;
determining an angle between the wind direction and a direction of an active flight segment;
computing the wind-optimal airspeed value by accessing the wind-optimal airspeed value look-up table incorporated in the PDB based on the aircraft type, the collected sensed wind condition, the determined angle, and the determined flight altitude value; and
generating a wind-optimal airspeed target value based on the computed wind-optimal airspeed value; and
the processing system is configured to perform operations such that adjusting the operational parameter of the aircraft by sending the active airspeed target value to the AFCS, the MCP, or the pilot based on the level of automation in the aircraft comprises using the generated wind-optimal airspeed target value to adjust the controls of the aircraft or provide advisories to the pilot to achieve or maintain the wind-optimal airspeed and guide the aircraft along an energy-efficient path.

18. The computing system of claim 11, wherein:
the processing system is configured to perform operations further comprising:
accessing PDB specific to the aircraft type;
collecting the sensed wind condition that includes the wind magnitude and the wind direction;
determining a great-circle distance between a current position of the aircraft and a waypoint in the flight plan;
collecting a forecasted wind condition along the flight plan;
blending the forecasted wind condition with the sensed wind condition to predict a wind condition at each waypoint in the flight plan;
determining an angle between a predicted wind condition and a direction of a segment of the flight plan ending at the waypoint in the flight plan;
determining the wind-optimal airspeed value based on the aircraft type, the determined angle, the predicted wind condition, and a flight altitude using the wind-optimal airspeed value look-up table incorporated in the PDB; and
predicting the wind-optimal airspeed value for the waypoint in the flight plan based on the determined wind-optimal airspeed value; and
the processing system is configured to perform operations such that adjusting the operational parameter of the aircraft by sending the active airspeed target value to the AFCS, the MCP, or the pilot based on the level of automation in the aircraft further comprises updating the flight plan based on the predicted wind-optimal airspeed value.

19. The computing system of claim 11, wherein the processing system includes or implements a flight management system (FMS).

20. A non-transitory computer-readable storage medium having stored thereon processor-executable software instructions configured to cause a processing system in a computing system of an aircraft to perform operations for operating an aircraft, the operations comprising:
determining a zero-wind airspeed value based on information stored in a performance database (PDB) of the aircraft and a selected speed mode;
determining a wind correction factor based on an aircraft type and a sensed wind condition, wherein the sensed wind condition includes a wind magnitude and a wind direction relative to a current segment of a flight plan of the aircraft;
generating a wind-optimal airspeed value by adding the determined wind correction factor to the determined zero-wind airspeed value;
determining an active airspeed target value based on the generated wind-optimal airspeed value; and
adjusting an operational parameter of the aircraft by sending the active airspeed target value to the automatic flight control system (AFCS), mode control panel (MCP), or pilot based on a level of automation in the aircraft.
